(19) United States
(12) Patent Application Publication
(10) Pub. No.: US 2025/0094926 A1
(43) Pub. Date: Mar. 20, 2025

(54) GENERATING AND PROCESSING BILATERAL COLLABORATION TOPIC DATA

(71) Applicant: Microsoft Technology Licensing, LLC, Redmond, WA (US)

(72) Inventors: Kateryna SOLONKO, Oslo (NO); Roman WERPACHOWSKI, Innalandet (NO); Simona Mirela CUCU, Oslo (NO); Knut Harald RYAGER, Oslo (NO); Ola SÆTROM, Oslo (NO); Mohammadreza BONYADI, Trondheim (NO); Espen Trautmann SOMMERFELT, Oslo (NO)

(21) Appl. No.: 18/467,630

(22) Filed: Sep. 14, 2023

(51) Int. Cl. G06Q 10/10; G06F 3/0482; G06Q 10/1093

(52) U.S. Cl. CPC G06Q 10/103; G06F 3/0482; G06Q 10/1095

(57) ABSTRACT

Technology is disclosed for programmatically identifying topics between a user and a contact of the user using a knowledge graph corresponding to the collaboration of the user and at least one of the user's contacts through various applications or platforms. The knowledge graph of the user includes (1) nodes corresponding to contacts, data objects, and topics extracted from the data objects and (2) edges corresponding to interactions between the contacts and data objects and (b) relationships between the data objects and topics. The knowledge graph is preprocessed in order to prune corresponding contacts, data objects, and/or topics. Following preprocessing of the knowledge graph, a subgraph of the knowledge is generated for each contact in order to identify, prune, and rank the topics for each contact. A number of the highest-ranked topics for each contact can be formatted for presentation to the user to provide an improved user computing experience.

### BACKGROUND

People spend significant time working with other people, including time collaborating, communicating or working with individuals on various documents, communications or in various meetings (also, increasingly, online meetings). In these meetings, collaborations on documents, and communications, it can be helpful for a user to know high-level topics that characterize the nature of the collaboration and/or communication between a user and each of their contacts. For example, when a user navigates to a certain contact or has a meeting scheduled with a certain contact, it would be helpful to provide the user with high-level information regarding the contact that is relevant to the user.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards technologies for improving electronic-communications computing applications and user computing experiences on user computing devices (sometimes referred to herein as mobile devices or user devices). In particular, this disclosure provides technologies to programmatically identify topics between a user and at least one contact of the user using a knowledge graph corresponding to the collaboration of the user and the contact through various applications or platforms. The knowledge graph includes nodes corresponding to contacts of the user, data objects that the user has interacted with, and topics extracted from the data objects. The knowledge graph also includes edges corresponding to relationships between the contacts and the data objects and relationships between the data objects and the topics. The knowledge graph is preprocessed in order to prune contact nodes, data object nodes, topic nodes, and/or edges between the nodes. Following preprocessing of the knowledge graph, a subgraph of the knowledge is generated for each contact in order to identify and prune the topics of the topics nodes within the subgraph for the particular contact. The topics are then ranked and a number of the highest-ranked topics for at least one of the user's contacts can be formatted for presentation to the user via a graphical user interface (GUI) element. In this regard, when a user navigates to a certain contact, has a meeting scheduled with a certain contact, receives a communication from a certain contact, or a similar interaction, topics for the certain contact can be presented to the user to facilitate communication with the certain contact regarding the topics.

### BRIEF DESCRIPTION OF THE DRAWINGS

Aspects of the disclosure are described in detail below with reference to the attached drawing figures, wherein:

FIG. 1 is a block diagram of an example operating environment suitable for implementations of the present disclosure;

FIG. 2 is a diagram depicting an example computing architecture suitable for implementing aspects of the present disclosure;

FIGS. 3A-3B illustratively depicts example diagrams of example knowledge graphs that are utilized to identify topics between a user and each contact of the user, in accordance with an embodiment of the present disclosure;

FIG. 4 illustratively depicts an example schematic screenshot from a personal computing device showing aspects of an example graphical user interface, in accordance with an embodiment of the present disclosure;

FIGS. 5-7 depict flow diagrams of methods for programmatically identifying topics between a user and each contact of the user using a knowledge graph, in accordance with an embodiment of the present disclosure;

FIG. 8 is a block diagram of an example computing environment suitable for use in implementing an embodiment of the present disclosure; and

FIG. 9 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

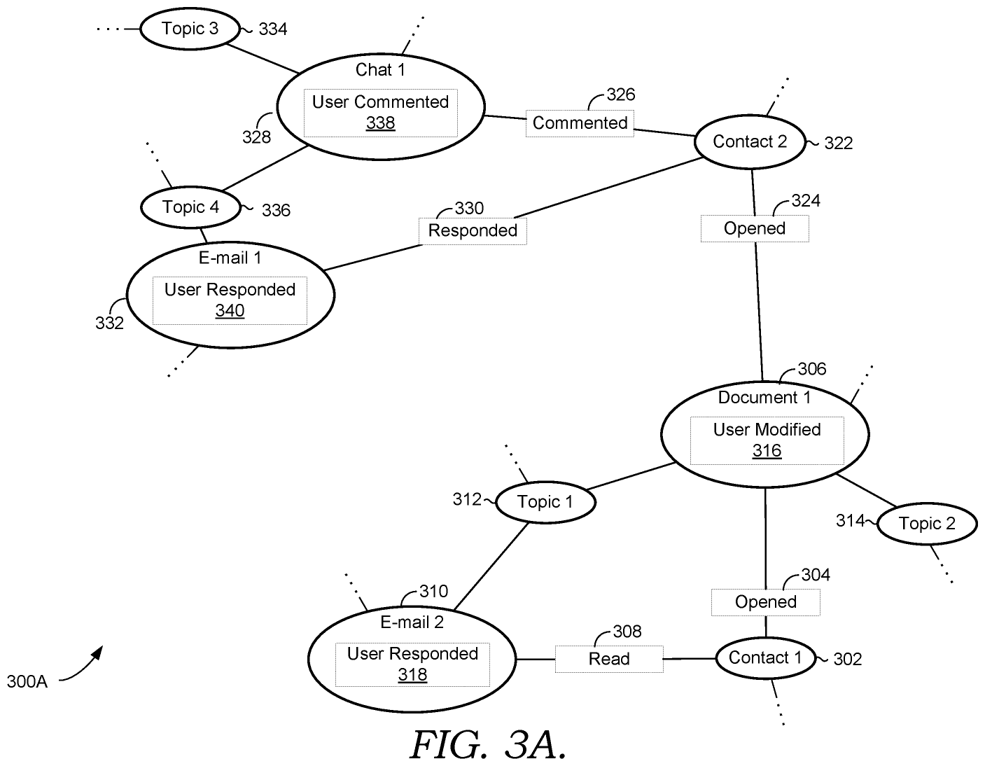

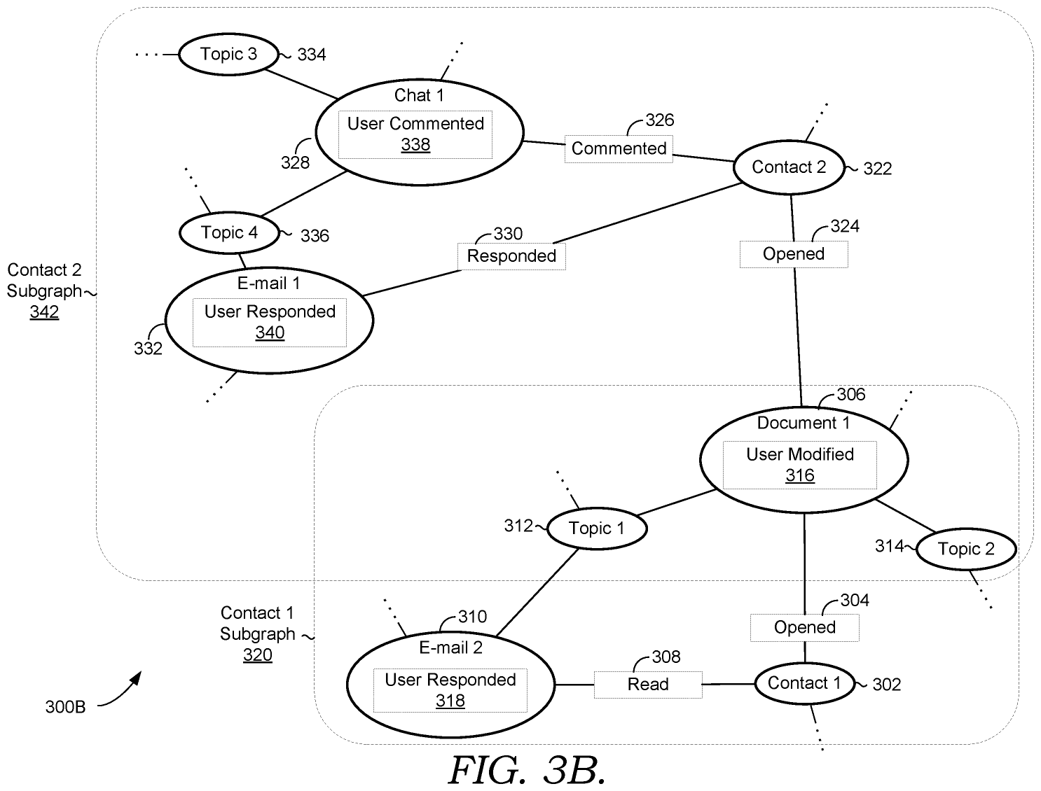

Aspects of the present disclosure relate to technology for improving electronic communication technology and enhanced computing services for a user, based on identifying topics between a user and each contact of the user. In particular, the solutions provided herein include technologies to programmatically identify topics between a user and each contact of the user using a knowledge graph. For example, a knowledge graph for a user corresponding to the collaboration of the user and each of their contacts through various applications or platforms can be stored and accessed. The knowledge graph includes nodes corresponding to contacts of the user, data objects that the user has interacted with, and topics extracted from the data objects. The knowledge graph also includes edges corresponding to relationships between the contacts and the data objects and relationships between the data objects and the topics. One example of such a knowledge graph is further described in connection with FIG. 3A.

Each of the contacts of the user may be sourced from a user's contact list from a particular communications application or platform, a network of contacts from a particular communications application or platform (for example, people from a particular organization or group within the particular organization), and/or contacts included on various communications or documents, such as e-mail threads, chat conversations, meetings, within documents or an edit history of the document, etc. Each of the data objects that the user has interacted with may include various communications or documents, such as e-mail threads, chat conversations, meetings, documents, etc. In this regard, the edges corresponding to relationships between the contacts and the data objects correspond to interactions between the contacts and the data objects. For example, an edge may indicate whether a particular contact has read or responded to an E-mail, whether a particular contact has opened or modified a document, whether a particular contact has read or commented in a chat, etc. Each of the topics extracted from the data objects can correspond to keywords (or key phrases) identified in the data objects by a language model, such as groups, projects, events, organizations, locations, products, etc. In this regard, the edges corresponding to relationships between the data objects and the topics correspond to which data objects the keywords were extracted from.

In some embodiments, features corresponding to the user's interactions with the data object may be stored in relation to the data object node, such as through metadata of the data object node. For example, features stored in relation to the data object node may indicate whether the user has read or responded to an E-mail, whether the user has opened or modified a document, whether the user has read or commented in a chat, etc.

In some embodiments, each of the nodes of the knowledge graph are ranked by the importance of each node, which is correlated with how many edges are connected to the node. For example, a contact node connected by edges to more data object nodes, which indicates that the contact interacted with more than one data object with the user, will be ranked higher than a contact node connected by edges to less data object nodes. As another example, a data object node connected by edges to more contact nodes, which indicates more than one contact has interacted with the data object, will be ranked higher than a data object node connected by edges to less contact nodes. As another example, a topic node connected by edges to more data object nodes, which indicates that the topic of the topic node was identified in more than one data object, will be ranked higher than a topic node connected by edges to less data object nodes. In some embodiments, the edges include edge weights to indicate the strength of the relationship which can be used to rank the importance of each node. For example, an edge between a topic node and data object node can have a larger edge weight when the topic of the topic node is mentioned more frequently in the data object of the data object node. In this regard, the topic node and/or data object node can be ranked higher based on the larger edge weight. As another example, an edge between a data object node and a contact node can have a larger edge weight when there are more interactions between the contact of the contact node and the data object of the data object node. In this regard, the contact node and/or data object node can be ranked higher based on the larger edge weight.

In some embodiments, the knowledge graph is preprocessed in order to prune contact nodes, data object nodes, and/or topic nodes. In this regard, the preprocessing of the knowledge graph reduces the size of data to be processed by narrowing down the amount of contacts for which topics are inferred, narrowing down the amount of data objects from the which the topics of are inferred, and narrowing down the amount of topics to remove “noisy” data that may lower the quality of the final result. In some embodiments, pruning and pre-processing are performed on the entire graph simultaneously.

In some embodiments, the knowledge graph can be preprocessed in order to prune contact nodes by removing (1) duplicate contacts (for example, the same person known via different e-mail addresses) and/or (2) non-human contacts (for example, distribution lists, automated accounts, etc.). In some embodiments, the knowledge graph can be preprocessed in order to prune contact nodes by ranking each contact node in order of importance and selecting the top N number of contacts or contacts above a threshold ranking.

In some embodiments, the knowledge graph can be preprocessed in order to prune data object nodes and/or topic nodes connected to the data object nodes by removing data object nodes without activity within a threshold period of time. For example, a data object node corresponding to a chat without activity in N number of days may be removed along with any topic nodes connected to the data object node of the chat.

In some embodiments, the knowledge graph can be preprocessed in order to prune topic nodes by removing (1) topic nodes connected to data object nodes without activity within a threshold period of time, (2) selected types of topics for topic nodes which are particularly noisy and lower quality (for example, the topics of the topic nodes were generated by less accurate topic extraction models), and/or (3) topics that are the same as contact names.

In some embodiments, the knowledge graph can be preprocessed in order to prune topic nodes by reducing the number of topic of the topic nodes by merging topics. For example, topics can be merged by merging multiples of a topic. In this regard, separate topics may be extracted from a data object(s) and stored as different topic nodes in the knowledge graph, but the topics may be variations of the same topic. As an example, triples of a topic with more than one word (for example, “team,” “product 1,” and “product 1 team”) may be extracted from a data object and stored as separate topics in separate topic nodes of the knowledge graph. In this regard, the separate topics in the separate topic nodes can be merged into a single topic of the longest length (in the example above, “product 1 team”). In some embodiments, topics are merged only if the maximum Jaccard distance between any pair of the sets of data objects of the data object nodes containing each topic is below a certain threshold.

As another example, the knowledge graph can be preprocessed in order to prune topic nodes by removing topics contained within other topics by clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated.

As another example, the knowledge graph can be preprocessed in order to prune topic nodes by removing topics from a single source. In this example, if a topic of a topic node is only connected to a data object nodes from a single source, such as only from calendar meetings, only in e-mails, only in text messages, only in documents, etc., the topic node can be removed. As another example, the knowledge graph can be preprocessed in order to prune topic nodes by removing topics which are not present in a specified set of required sources. In this example, if a topic of a topic node is not connected to one data object node from a specified set of required sources, for example, the topic of the topic node is only connected to data object nodes from an e-mail source and a meeting source, but the specified set of required sources requires a document source, the e-mail source and a meeting source, the topic node can be removed.

In some embodiments, settings may be presented in a user interface to independently turn on or off each of one or more of the embodiments and examples of preprocessing the knowledge graph described above through configuration settings presented to the user.

In some embodiments, a subgraph of the knowledge is generated for each contact in order to identify and prune the topics of the topics nodes within the subgraph for the particular contact to infer a set of candidate topics for the particular contact. In this regard, important topics the user collaborated on with each of their contacts can be inferred from a sub-graph of the user's graph containing only the nodes connected with the particular contact node of the contact, thereby reducing noise from other nodes/edges. One example of such a subgraph of a knowledge graph generated for each contact is further described in connection with FIG. 3B. In some embodiments, identifying and pruning the topics for each contact within the subgraph for the contact occurs after preprocessing the knowledge graph.

In some embodiments, identifying the topics for each contact within the subgraph for the contact includes ranking each topic node in order of importance and selecting the top N number of topics from the topic nodes above a threshold ranking. For example, for each contact through a corresponding subgraph for the contact, up to N top ranked topics from the topic nodes of the subgraph using a PageRank algorithm. As an example, the PageRank algorithm may include alpha=0.5 and a maximum number of 5 iterations.

In some embodiments, pruning the topics for each contact within the subgraph for the contact includes clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated. In some instances, performing clustering for the subgraph of the contact is less computationally expensive than during preprocessing the knowledge graph as there likely is a smaller number of topics.

In some embodiments, after clustering and merging topics, the process of identifying the topics for each contact within the subgraph for the contact by ranking each topic node in order of importance and selecting the top N number of topics from the topic nodes above a threshold ranking is repeated.

In some embodiments, pruning the topics for each contact within the subgraph for the contact includes removing topics inferred for more than a given percentage of contacts. For example, if a topic was identified for more than 50% of contacts, the topic is removed. As a more specific example, if all of the user's contacts belong to the same team, named “The A-Team,” every contact may get a topic inferred corresponding to the “The A-Team,” which would not necessarily be information about the collaboration between the user and the specific contact.

In some embodiments, for each contact sub-graph, pruning the topics for each contact within the subgraph for the contact includes repeating reducing the number of topic of the topic nodes by merging topics, removing topics contained within other topics, and/or any other process of the knowledge graph preprocessing. In some embodiments, repeating reducing the number of topic of the topic nodes by merging topics, removing topics contained within other topics, and/or any other process of the knowledge graph preprocessing for each subgraph of each contact occurs after removing topics inferred for more than a given percentage of contacts.

In some embodiments, for each candidate topic inferred (for example, after identifying and pruning the topics of the topics nodes for each contact within the subgraph for the particular contact to infer a set of candidate topics for the particular contact), (1) the number of data object nodes connected to each topic is computed and/or (2) the total weight of all edges from the topic node to the data object nodes (referred to herein as “topic frequency”) is computed.

In some embodiments, the set of candidate topics inferred for each contact are ranked. For example, each candidate topic in the set of candidate topics can be ranked using term frequency-inverse document frequency (“tf-idf”), term frequency*proportional document frequency (“tf*pdf”) and/or any related algorithm. As another example, the identified and pruned topics for each contact are ranked according to the topic frequency and/or the number of content nodes connected to the topic node of the topic.

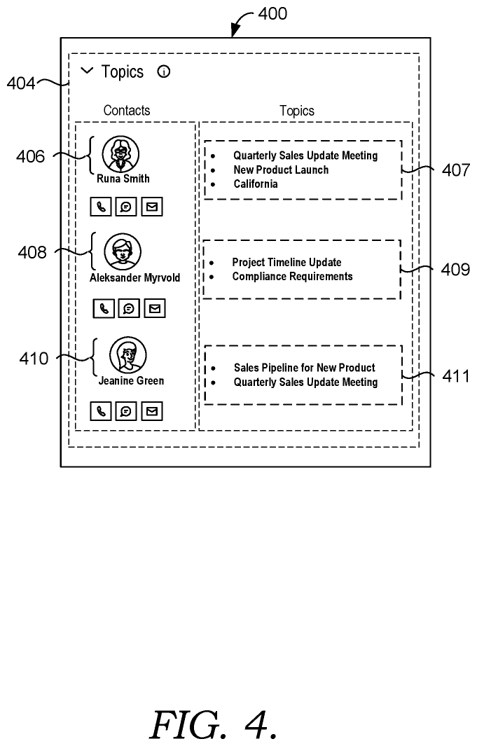

In some embodiments, a preset number of topics for each contact is presented to the user from the ranked set of candidate topics. For example, a set of topic information items for each contact (or a portion thereof) may be assembled and formatted or prepared for presentation to the user via a graphical user interface (GUI) element, which may be modified to depict information regarding the topics for each contact. One example of such a GUI element is further described in connection with FIG. 4.

In this regard, one or more topics for the certain contact (or set of contacts) can be presented to the user to facilitate communication with the certain contact (or each contact in set of contacts) regarding the topics. For example, in one embodiment, when a user navigates to a certain contact or is presented information about the contact, the highest-ranked topics for the certain contact can be presented to the user via a GUI. When the user communicates with the certain contact, such as by call, text, chat, message, email, or other communication, the user can address the particular topic from the presented topics in the user's communication to the certain contact without having to manually identify topics between the user and the certain contact. As another example, when a user has a meeting scheduled with a certain contact, the highest-ranked topics for the certain contact can be presented to the user via a GUI. In one embodiment, the GUI is presented via an online meeting application, such as TEAMS® by Microsoft® or the GUI may be presented as part of a live persona card in response to the user hovering their cursor over an indication of the certain contact. The user can address one or more of the presented topics during the meeting with the certain contact without having to manually identify the topics or frequent topics of communication between the user and the certain contact. As another example, when a user receives a communication from a certain contact, one or more topics for the certain contact can be presented to the user via a GUI. In one embodiment, the GUI is presented in a messaging application such as Outlook® by Microsoft®. For instance, when the user views or responds to a communication with the certain contact, such as by call, text, chat, message, email, etc., the user is presented with the topic via the GUI. In this way, the user is enabled to address the topic in the user's response to the certain contact without having to manually identify the topics between the user and the certain contact. Further, in this way, and as further described herein, computer resources including computer processing, memory, and network communication bandwidth are conserved because a user is not required to access and review prior communications, which may exist across multiple channels (for example, email, messages, meetings), in order to determine the topics.

In some embodiments, a user or a third party can display topics between two or more other users. For example, a user can approve the display of topics between the user and contacts of the user in order to display the topics to a different user or a third party. For example, a user discusses a certain project frequently with other contacts and wishes to share the topic between the user and the other contacts with a third party or a different user. In this regard, the topic between the user and their contacts can be shared with the different user or third party. In some embodiments, the user can select a setting in a user interface whether to share topics between the user and the user's contacts with a different user or third party for privacy considerations.

The solutions provided by the present disclosure further enable improved control over the processing and presentation or display of topic data for each contact of a user on computing devices. In some embodiments, the operation of a computer application, such as a communications application, may be configured or modified to execute computer instructions for presenting a GUI element comprising a set of topic information items for each contact (or a portion thereof) in response to a user interacting with a contact or an indication of the contact, or a user interacting with or an indication of GUI element for topic information for each contact, via the computing application. The topic data for each contact may be assembled into a data structure associated with each contact, and also may be used for the provisioning of new communication application functionality and/or for displaying the topic data for each contact on a user device for the viewing user. In particular, the topic data for each contact may be used for, among other beneficial computing applications, providing enhanced functionality for communication and collaborative computing applications, improved meeting-scheduling computer services and electronic-messaging applications, and displaying aspects of the topic data for each contact on a user device based upon a context. Thus, by determining and processing topic data for each contact differently than conventional technology, embodiments of this disclosure enable the provision of new functionality for electronic communications computing applications, as well as improved efficiency for electronic communication, enriched electronic communications, and improved computing experiences for users, such as personalized computing experiences, among other improvements described herein.

### Overview of Technical Problems, Technical Solutions, and Technological Improvements

The coalescence of telecommunications and personal computing technologies in the modern era has enabled, for the first time in human history, information on demand and an ubiquity of personal computing resources (including mobile personal computing devices and cloud-computing coupled with communication networks). As a result, it is increasingly common for users to rely on one or more mobile computing devices throughout the day for handling various tasks.

As described previously, people spend significant time working with, communicating with and in meetings with other people, including time collaborating, communicating or working with individuals on various documents, communications or in various meetings, and it can be helpful for a user to have high-level topics that characterize the nature of the collaboration and/or communication between a user and each of their contacts. For example, when a user navigates to a certain contact or has a meeting scheduled with a certain contact, it would be helpful to provide the user with high-level information regarding the contact that is relevant to the user.

However, the conventional technology lacks computing functionality to programmatically automatically identify topics between a user and each contact of the user, nor does the conventional technology include functionality for using the identified topics between a user and each contact of the user to provide improved computing applications and an improved user computing experience. Consequently, because conventional technology lacks this functionality, determining topics for a user and their contacts requires the user to manually identify and access data from storage between the user and their contacts. For example, the user must manually identify and then access prior communications across various channels including email and chats, meeting transcripts, recordings, and other meeting data, documents, and comments in documents, and other communications. This data then must be manually reviewed to determine topics associated with the data. Accordingly, existing approaches for determining topic data about a user's contacts requires manual curation and preparation of information by a human. For example, an administrator, or the user themselves, must first manually specify a contact and then look up and aggregate data about the contact in order to identify topic data regarding the contact. Unfortunately, because the topic data must be manually determined by a human, the process is time-consuming, labor intensive, and computationally expensive in order to access data from storage, process the data for presentation, manually review the data, and manually sift through the data. In this regard, additional computing and network resources must be utilized, such as increased processing requirements due to increased input/output operations, increased network bandwidth utilization when the data is transmitted over a network, when accessed by the user, and in some instances, longer and less efficient communication sessions between the user and their contacts because the topics relevant to the user and their contacts are not known to the user.

Further, even where the user has completed the arduous task of manually determining topics for a particular contact by accessing data as described previously, the conventional technology lacks functionality for presenting the topics, nor for presenting the topics in regards to a particular contact in a context of the user communicating with the contact or initiating communication with the contact. Further still, topics between a user and their contacts change over time and user's manually determined topics may become irrelevant if the user is not continuously updating the manually determined topics. Even further, certain topics may be overlooked due to human error or because the user is unaware of the contact's involvement with certain documents, meetings, communications, etc.

Accordingly, automated computing technology for programmatically determining topics between a user and each contact of the user by utilizing a knowledge graph corresponding to the collaboration of the user and each of their contacts through various applications or platforms, as provided herein, can be beneficial for enabling improved computing applications and an improved user computing experience. For example, automated computing technology for programmatically identifying topics between a user and each contact of the user reduces the computing and networking resources utilized during communication between the user and a contact by facilitating suggestions of relevant topics so that the user is not required to manually identify, access, process, and review data between the contact and the user each time the user communicates with the contact. In this regard, the computing and network resources are conserved. Further, embodiments of this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Further still, embodiments described herein enable certain topic data for each contact of a user to be programmatically determined and presented without requiring computer tools and resources for a user to manually perform operations to produce this outcome. In this way, some embodiments, as described herein, reduce or eliminate a need for certain databases, data storage, and computer controls for enabling manually performed steps by an administrator, or the user themselves, to search, identify, assess, and configure (e.g., by hard-coding) specific, static data, thereby reducing the consumption of computing resources.

### Additional Description of the Embodiments

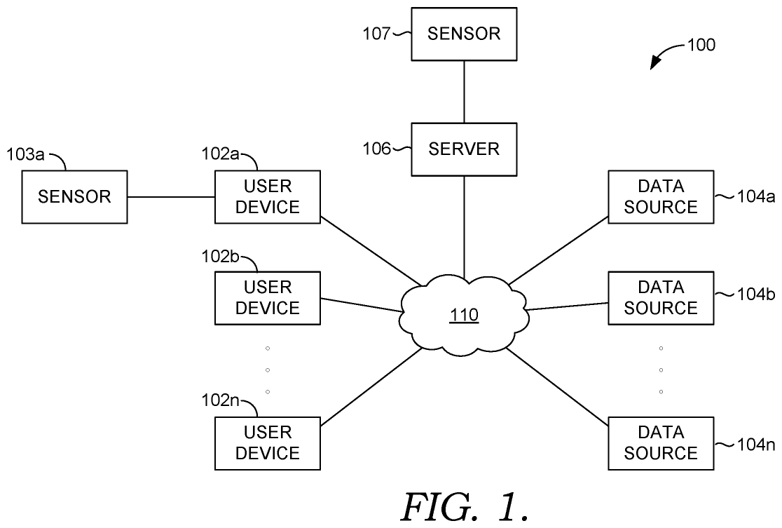

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

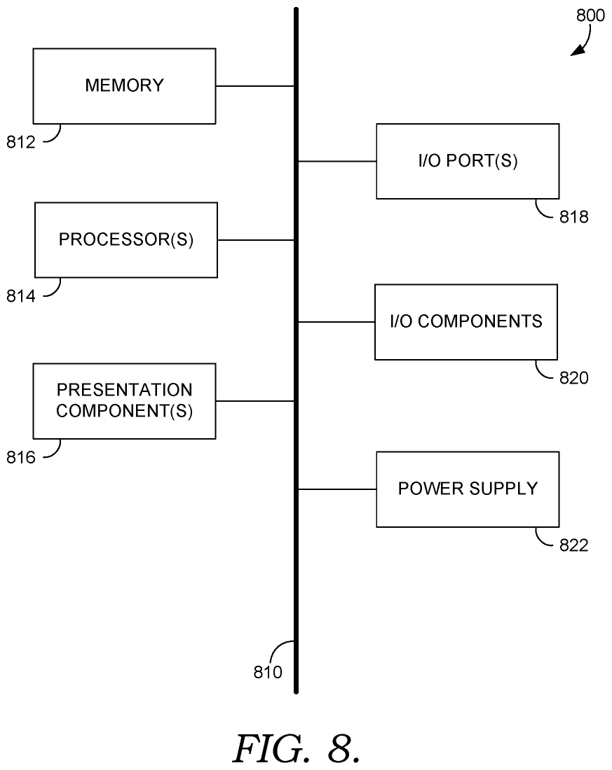

Among other components not shown, example operating environment 100 includes a number of user computing devices, such as: user devices 102a and 102b through 102n; a number of data sources, such as data sources 104a and 104b through 104n; server 106; sensors 103a and 107; and network 110. It should be understood that environment 100 shown in FIG. 1 is an example of one suitable operating environment. Each of the components shown in FIG. 1 may be implemented via any type of computing device, such as computing device 800 described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 8 herein. By way of example and not limitation, a user device may be embodied as a personal computer (PC), a laptop computer, a mobile or mobile device, a smartphone, a smart speaker, a tablet computer, a smart watch, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, any other suitable computer device, or any combination of these delineated devices.

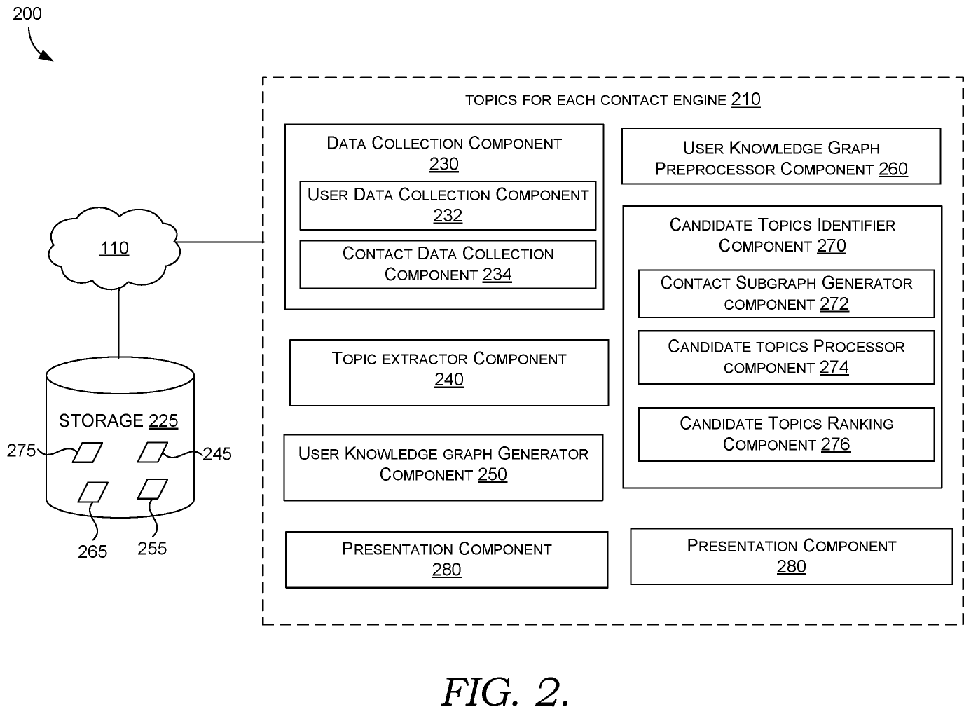

Data sources 104a and 104b through 104n may comprise data sources and/or data systems, which are configured to make data available to any of the various constituents of operating environment 100 or system 200 described in connection to FIG. 2. For instance, in one embodiment, one or more data sources 104a through 104n provide (or make available for accessing), to data collection component 230 of FIG. 2, user data through user data collection component 232, which may include user-activity related data with respect to various data objects and contact data through contact data collection component 234, which may include contact-activity related data with various data objects. Data sources 104a and 104b through 104n may be discrete from user devices 102a and 102b through 102n and server 106 or may be incorporated and/or integrated into at least one of those components. In one embodiment, one or more of data sources 104a through 104n comprise one or more sensors, which may be integrated into or associated with one or more of the user device(s) 102a, 102b, or 102n or server 106. Examples of sensed people data made available by data sources 104a through 104n are described further in connection to data collection component 230 of FIG. 2.

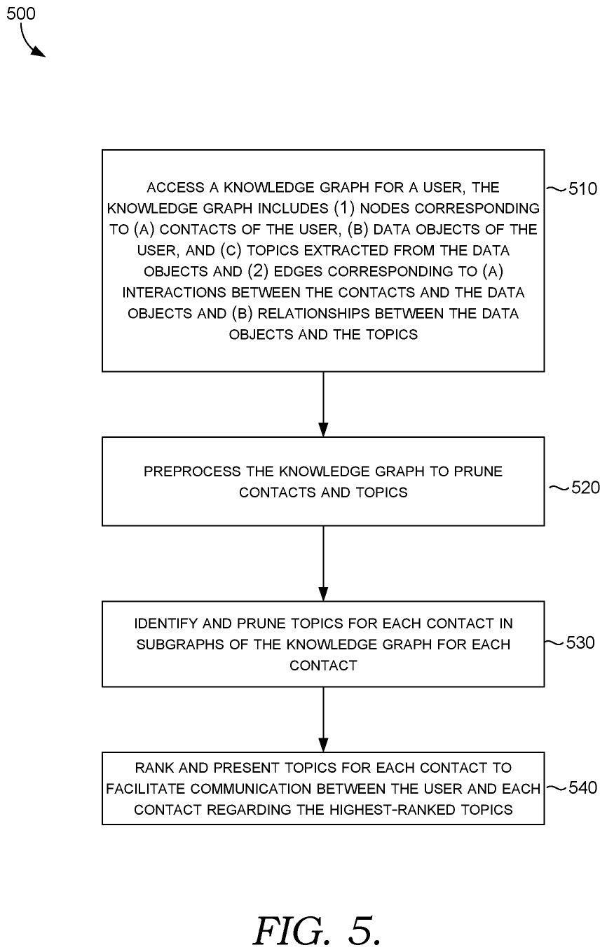

Operating environment 100 can be utilized to implement one or more of the components of system 200, described in FIG. 2. Operating environment 100 can also be utilized for implementing aspects of methods 500, 600, and 700 in FIGS. 5-7, respectively.

Referring now to FIG. 2, with continuing reference to FIG. 1, a block diagram is provided showing aspects of an example computing system architecture suitable for implementing an embodiment of this disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200, including topics for each contact engine 210, and storage 225. Topics for each contact engine 210 communicatively couples components of system 200 including data collection component 230 (including its subcomponents user data collection component 232 and contact data collection component 234), topic extractor component 240, user knowledge graph generator component 250, user knowledge graph preprocessor component 260, candidate topics identifier component 270 (including its subcomponents contact subgraph generator component 272, candidate topics processor component 274, and candidate topics ranking component 276), candidate topic for each contact ranking component 280, and presentation component 280, may be embodied as a set of compiled computer instructions or functions, program modules, computer software services, or an arrangement of processes carried out on one or more computer systems, such as computing device 800, described in connection to FIG. 8, for example.

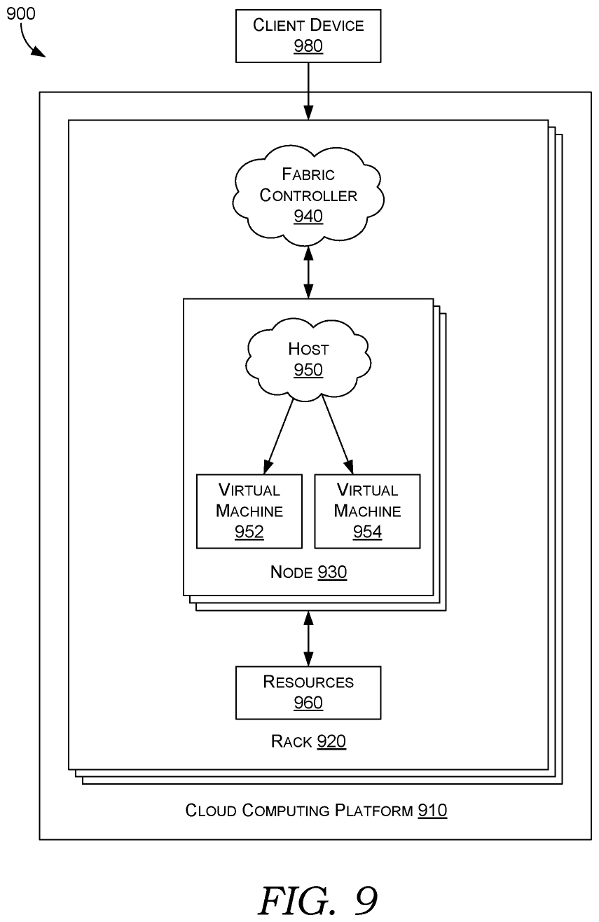

In one embodiment, the functions performed by components of system 200 are associated with one or more computer applications, services, or routines, such as an online meeting application, a communications or collaboration application, etc. The functions may operate to identify topics between a user and each contact of the user, or otherwise to provide an enhanced computing experience for the user. In particular, such applications, services, or routines may operate on one or more user devices (such as user device 102a) or servers (such as server 106). Moreover, in some embodiments, these components of system 200 may be distributed across a network, including one or more servers (such as server 106) and/or client devices (such as user device 102a) in the cloud, such as described in connection with FIG. 9, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. Additionally, although functionality is described herein with regard to specific components shown in example system 200, it is contemplated that in some embodiments, functionality of these components can be shared or distributed across other components.

Continuing with FIG. 2, data collection component 230 is generally configured to access or receive (and in some cases also identify) data, which may include user data through user data collection component 232, which may include user-activity related data with respect to data objects and contact data through contact data collection component 234, which may include contact-activity related data with respect to data objects from one or more data sources, such as data sources 104a and 104b through 104n of FIG. 1. In some embodiments, user-data collection component 210 may be employed to facilitate the accumulation of user data of a particular user, contact data, object data, and/or topic data for topic extractor component 240, user knowledge graph generator component 250, user knowledge graph preprocessor component 260, candidate topics identifier component 270 or its subcomponents, candidate topic for each contact ranking component 280, or presentation component 280. The data may be received (or accessed), and optionally accumulated, reformatted, and/or combined, by data collection component 230 or its subcomponents and stored in one or more data stores such as storage 225, where it may be available to other components of system 200. In some embodiments, any personally identifying data (i.e., user data, contact data, object data, or topic data) that specifically identifies particular users) is either not uploaded or otherwise provided from the one or more data sources, is not permanently stored, is de-identified, and/or is not made available to other components of system 200. In addition or alternatively, in some embodiments, a user may opt into or out of services provided by the technologies described herein and/or select which user data and/or which sources of user data are to be captured and utilized by these technologies.

User data, generally, may comprise any information that is related to a person that informs a user about an aspect of that person, and may be received from a variety of sources and may be available in a variety of formats. By way of example and without limitation, user data may comprise data of a user with respect to various data objects, such as: contact information (e.g., email, instant message, phone, and may also specify a person's communication preferences); location information (e.g., a person's current location or location of a particular office where they work); presence; user-related activity, which may comprise activity relevant to a user, such as communications information (e.g., past email, meetings, chat sessions, communication patterns or frequency, information about a user or users that had a meeting with or has an upcoming meeting with, or information about communications between one or more users), files access (e.g., a file created, modified, or shared), social media or online activity, such as a post to a social-media platform or website, subscription information, information regarding topics of interest to a user, or other user-related activity that may be determined via a user device; task-related information (e.g., an outstanding task that the user has with regard to outstanding tasks); or information in common with the user (e.g., common project teams, work groups, backgrounds, education, interests, or hobbies). Additional examples of user data are described herein.

In some embodiments, user data received via user data collection component 232 may be obtained from a data source (such as data source 104(a) in FIG. 1, which may be a social networking site, a professional networking site, a corporate network, an organization intranet or file share, or other data source containing user data) or determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed, detected, or determined from one or more sensors (referred to herein as sensor data), such as location information of mobile device(s), properties or characteristics of the user device(s), user-activity information (for example: app usage; online activity; searches; voice data such as automatic speech recognition; activity logs; communications data, including calls, texts, chats, messages, and emails; document comments; website posts; other user data associated with communication events, including user history, session logs, application data, contacts data, calendar and schedule data, notification data, social-network data, ecommerce activity, user-account(s) data (which may include data from user preferences or settings associated with a personalization-related application, a personal assistant application or service, an online service or cloud-based account such as Microsoft 365, an entertainment or streaming media account, a purchasing club or services); global positioning system (GPS) data; other user device data (which may include device settings, profiles, network-related information, payment or credit card usage data, or purchase history data); other sensor data that may be sensed or otherwise detected by a sensor (or other detector) component(s), including data derived from a sensor component associated with the user (including location, motion, orientation, position, user-access, user-activity, network-access, user-device charging, or other data that is capable of being provided by one or more sensor component); data derived based on other data (for example, location data that can be derived from Wi-Fi, cellular network, or IP address data), and nearly any other source of data that may be sensed, detected, or determined as described herein. In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user data collection component 232 receives or accesses data continuously, periodically, as it becomes available, or as needed. In some embodiments, the user data may be received by user data collection component 232 is stored in storage 225.

Contact data, generally, may comprise any information that is related to a contact of a user that informs a user about an aspect of that contact, and may be received from a variety of sources and may be available in a variety of formats. By way of example and without limitation, contact data may comprise data of a user with respect to various data objects, such as: contact information (e.g., email, instant message, phone, and may also specify a person's communication preferences); location information (e.g., a person's current location or location of a particular office where they work); presence; contact-related activity, which may comprise activity relevant to a contact, such as communications information (e.g., past email, meetings, chat sessions, communication patterns or frequency, information about a contact or contacts that had a meeting with or has an upcoming meeting with, or information about communications between one or more contacts), files access (e.g., a file created, modified, or shared), social media or online activity, such as a post to a social-media platform or website, subscription information, information regarding topics of interest to a contact, or other contact-related activity that may be determined via a user device of the contact; task-related information (e.g., an outstanding task that the contact has with regard to outstanding tasks); or information in common with the contact (e.g., common project teams, work groups, backgrounds, education, interests, or hobbies). Additional examples of contact data are described herein.

In some embodiments, contact data received via contact data collection component 234 may be obtained from a data source (such as data source 104(a) in FIG. 1, which may be a social networking site, a professional networking site, a corporate network, an organization intranet or file share, or other data source containing contact) or determined via one or more sensors (such as sensors 103a and 107 of FIG. 1), which may be on or associated with one or more user devices of a contact (such as user device 102a), servers (such as server 106), and/or other computing devices. As used herein, a sensor may include a function, routine, component, or combination thereof for sensing, detecting, or otherwise obtaining information such as contact data from a data source 104a, and may be embodied as hardware, software, or both. By way of example and not limitation, contact data may include data that is sensed, detected, or determined from one or more sensors (referred to herein as sensor data), such as location information of mobile device(s), properties or characteristics of the user device(s) of a contact, contact-activity information (for example: app usage; online activity; searches; voice data such as automatic speech recognition; activity logs; communications data, including calls, texts, chats, messages, and emails; document comments; website posts; other contact data associated with communication events, including contact history, session logs, application data, contacts data, calendar and schedule data, notification data, social-network data, ecommerce activity, contact-account(s) data (which may include data from contact preferences or settings associated with a personalization-related application, a personal assistant application or service, an online service or cloud-based account such as Microsoft 365, an entertainment or streaming media account, a purchasing club or services); global positioning system (GPS) data; other user device data from a user device of the contact (which may include device settings, profiles, network-related information, payment or credit card usage data, or purchase history data); other sensor data that may be sensed or otherwise detected by a sensor (or other detector) component(s), including data derived from a sensor component associated with the contact (including location, motion, orientation, position, contact-access, contact-activity, network-access, contact-device charging, or other data that is capable of being provided by one or more sensor component); data derived based on other data (for example, location data that can be derived from Wi-Fi, cellular network, or IP address data), and nearly any other source of data that may be sensed, detected, or determined as described herein. In some respects, contact data may be provided in contact-data streams or signals. A “contact signal” can be a feed or stream of contact data from a corresponding data source. For example, a contact signal could be from a smartphone, a home-sensor device, a GPS device (e.g., for location coordinates), a vehicle-sensor device, a wearable device, a user device of the contact, a gyroscope sensor, an accelerometer sensor, a calendar service, an email account, a credit card account, or other data sources. In some embodiments, contact data collection component 234 receives or accesses data continuously, periodically, as it becomes available, or as needed. In some embodiments, the contact data may be received by contact data collection component 234 is stored in storage 225.

Continuing with FIG. 2, topic extractor component 240 is generally responsible for extracting topics from data objects corresponding to keywords (or key phrases) identified in the data objects. Embodiments of topic extractor component 240 extract keywords corresponding to topics from data objects based on data collected by data collection component 230, such a user data collected by user data collection component 232 and contact data collected by contact data collection component 234. Thus, information about data objects from the user data and contact data collected by data collection component 230 may be accessed by topic extractor component 240 in storage 225. The data of the topics extracted by topic extractor component 240 may be stored storage 225, where it may be used by other components or subcomponents of system 200.

Embodiments of topic extractor component 240 may extract topics from the data objects corresponding to keywords (or key phrases) identified in the data objects by a language model, such as groups, projects, events, organizations, locations, products, etc. In this regard, the edges corresponding to relationships between the data objects and the topics correspond to which data objects the keywords were extracted from.

Some embodiments of topic extractor component 240 utilize topic extractor logic 245 stored in storage 225 to extract topics from data objects. In particular, topic extractor logic 245 may comprise computer instructions including rules, conditions, associations, classification models, or other criteria for, among other operations, extracting topics from data objects. Topic extractor logic 245 may take different forms, depending on the particular information items being determined, extracted, and/or processed. For example, Topic extractor logic 245 may comprise a set of rules, such as Boolean logic, various decision trees (e.g., random forest, gradient boosted trees, or similar decision algorithms), conditions or other logic, fuzzy logic, neural network, finite state machine, support vector machine, machine-learning techniques, such as a language model, or combinations of these to extract (or facilitated extracting) topics from data objects.

Continuing with FIG. 2, user knowledge graph generator component 250 is generally responsible for generating a knowledge graph for a user corresponding to the collaboration of the user and each of their contacts through various applications or platforms. Embodiments of user knowledge graph generator component 250 may generate a knowledge graph based on data collected by data collection component 230, such a user data collected by user data collection component 232, contact data collected by contact data collection component 234, topics extracted by topic extractor component 240. Thus, information about data objects with respect to a user and/or contact's interactions with the data objects collected by data collection component 230 may be accessed by user knowledge graph generator component 250 in storage 225. Further, information about topics extracted from data objects by topic extractor component 240 may be accessed by user knowledge graph generator component 250 in storage 225. The data of the knowledge graph generated by user knowledge graph generator component 250 may be stored storage 225, where it may be used by other components or subcomponents of system 200.

Embodiments of user knowledge graph generator component 250 may generate a knowledge graph for a user corresponding to the collaboration of the user and each of their contacts through various applications or platforms can be stored and accessed. The knowledge graph generated by user knowledge graph generator component 250 can include nodes corresponding to contacts of the user, data objects that the user has interacted with, and topics extracted from the data objects. The knowledge graph generated by user knowledge graph generator component 250 can also include edges corresponding to relationships between the contacts and the data objects and relationships between the data objects and the topics. One example of such a knowledge graph is further described in connection with FIG. 3A.

Each of the contacts nodes corresponding to contacts of the user generated by user knowledge graph generator component 250 in the user knowledge graph may be contacts from a user's contact list from a particular communications application or platform, a network of contacts from a particular communications application or platform (for example, people from a particular organization or group within the particular organization), and/or contacts included on various communications or documents, such as e-mail threads, chat conversations, meetings, within documents or an edit history of the document, etc. Each of the data object nodes corresponding to data objects generated by user knowledge graph generator component 250 in the user knowledge graph that the user has interacted with may include various communications or documents, such as e-mail threads, chat conversations, meetings, documents, etc. In this regard, the edges generated by user knowledge graph generator component 250 in the user knowledge graph corresponding to relationships between the contacts and the data objects correspond to interactions between the contacts and the data objects. For example, an edge generated by user knowledge graph generator component 250 in the user knowledge graph may indicate whether a particular contact has read or responded to an E-mail, whether a particular contact has opened or modified a document, whether a particular contact has read or commented in a chat, etc. Each of the topic nodes corresponding to topics extracted from the data objects generated by user knowledge graph generator component 250 in the user knowledge graph can correspond to keywords (or key phrases) identified in the data objects by a language model, such as groups, projects, events, organizations, locations, products, etc. In this regard, the edges generated by user knowledge graph generator component 250 in the user knowledge graph corresponding to relationships between the data objects and the topics correspond to which data objects the keywords were extracted from.

In some embodiments, features generated by user knowledge graph generator component 250 in the user knowledge graph corresponding to the user's interactions with the data object may be stored in storage 225 in relation to the data object node, such as through metadata of the data object node. For example, features generated by user knowledge graph generator component 250 in the user knowledge graph stored in relation to the data object node may indicate whether the user has read or responded to an E-mail, whether the user has opened or modified a document, whether the user has read or commented in a chat, etc.

In some embodiments, each of the nodes generated by user knowledge graph generator component 250 in the user knowledge graph are ranked by the importance of each node, which is correlated with how many edges are connected to the node. For example, a contact node connected by edges to more data object nodes, which indicates that the contact interacted with more than one data object with the user, will be ranked higher than a contact node connected by edges to less data object nodes. As another example, a data object node connected by edges to more contact nodes, which indicates more than one contact has interacted with the data object, will be ranked higher than a data object node connected by edges to less contact nodes. As another example, a topic node connected by edges to more data object nodes, which indicates that the topic of the topic node was identified in more than one data object, will be ranked higher than a topic node connected by edges to less data object nodes.

In some embodiments, the edges generated by user knowledge graph generator component 250 in the user knowledge graph include edge weights to indicate the strength of the relationship which can be used to rank the importance of each node. For example, an edge between a topic node and data object node can have a larger edge weight when the topic of the topic node is mentioned more frequently in the data object of the data object node. In this regard, the topic node and/or data object node can be ranked higher based on the larger edge weight. As another example, an edge between a data object node and a contact node can have a larger edge weight when there are more interactions between the contact of the contact node and the data object of the data object node. In this regard, the contact node and/or data object node can be ranked higher based on the larger edge weight.

Some embodiments of user knowledge graph generator component 250 utilize user knowledge graph generator logic 255 stored in storage 225 to generate a knowledge graph. In particular, user knowledge graph generator logic 255 may comprise computer instructions including rules, conditions, associations, classification models, or other criteria for, among other operations, determining nodes corresponding to contacts of the user, data objects that the user has interacted with and topics extracted from the data objects, and determining edges corresponding to relationships between the contacts and the data objects and relationships between the data objects and the topics, or any of the embodiments described herein. User knowledge graph generator logic 255 may take different forms, depending on the particular information items being determined, extracted, and/or processed. For example, user knowledge graph generator logic 255 may comprise a set of rules, such as Boolean logic, various decision trees (e.g., random forest, gradient boosted trees, or similar decision algorithms), conditions or other logic, fuzzy logic, neural network, finite state machine, support vector machine, machine-learning techniques, or combinations of these to determine (or facilitate determining) nodes and edges according to embodiments described herein.

Continuing with FIG. 2, user knowledge graph preprocessor component 260 is generally responsible for preprocessing the user knowledge graph. Embodiments of user knowledge graph preprocessor component 260 may preprocess the user knowledge graph generated by user knowledge graph generator component 250 in order to prune contact nodes, data object nodes, and/or topic nodes of the user knowledge graph. Thus, information regarding the user knowledge graph generated by user knowledge graph generator component 250 may be accessed by user knowledge graph preprocessor component 260 in storage 225. The data of the preprocessed knowledge graph generated by user knowledge graph preprocessor component 260 may be stored storage 225, where it may be used by other components or subcomponents of system 200.

Embodiments of user knowledge graph preprocessor component 260 may preprocess the user knowledge graph generated by user knowledge graph generator component 250 to reduce the size of data to be processed by narrowing down the amount of contacts for which topics are inferred, narrowing down the amount of data objects from the which the topics of are inferred, and narrowing down the amount of topics to remove “noisy” data that may lower the quality of the final result. In some embodiments, pruning and pre-processing by user knowledge graph preprocessor component 260 are performed on the entire user knowledge graph simultaneously.

In some embodiments, user knowledge graph preprocessor component 260 may preprocess the user knowledge graph by removing (1) duplicate contacts (for example, the same person known via different e-mail addresses) and/or (2) non-human contacts (for example, distribution lists, automated accounts, etc.). In some embodiments, user knowledge graph preprocessor component 260 may preprocess the user knowledge graph in order to prune contact nodes by ranking each contact node in order of importance and selecting the top N number of contacts or contacts above a threshold ranking.

In some embodiments, user knowledge graph preprocessor component 260 may preprocess the user knowledge graph in order to prune data object nodes and/or topic nodes connected to the data object nodes by removing data object nodes without activity within a threshold period of time. For example, a data object node corresponding to a chat without activity in N number of days may be removed along with any topic nodes connected to the data object node of the chat.

In some embodiments, user knowledge graph preprocessor component 260 may preprocess the user knowledge graph in order to prune topic nodes by removing (1) topic nodes connected to data object nodes without activity within a threshold period of time, (2) selected types of topics for topic nodes which are particularly noisy and lower quality (for example, the topics of the topic nodes were generated by less accurate topic extraction models), and/or (3) topics that are the same as contact names.

In some embodiments, user knowledge graph preprocessor component 260 may preprocess the user knowledge graph in order to prune topic nodes by reducing the number of topic of the topic nodes by merging topics. For example, topics can be merged by merging multiples of a topic. In this regard, separate topics may be extracted from a data object(s) and stored as different topic nodes in the knowledge graph, but the topics may be variations of the same topic. As an example, triples of a topic with more than one word (for example, “team,” “product 1,” and “product 1 team”) may be extracted from a data object and stored as separate topics in separate topic nodes of the knowledge graph. In this regard, the separate topics in the separate topic nodes can be merged into a single topic of the longest length (in the example above, “product 1 team”). In some embodiments, topics are merged only if the maximum Jaccard distance between any pair of the sets of data objects of the data object nodes containing each topic is below a certain threshold.

As another example, user knowledge graph preprocessor component 260 may preprocess the user knowledge graph in order to prune topic nodes by removing topics contained within other topics by clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated.

As another example, user knowledge graph preprocessor component 260 may preprocess the user knowledge graph in order to prune topic nodes by removing topics from a single source. In this example, if a topic of a topic node is only connected to a data object nodes from a single source, such as only from calendar meetings, only in e-mails, only in text messages, only in documents, etc., the topic node can be removed. As another example, the knowledge graph can be preprocessed in order to prune topic nodes by removing topics which are not present in a specified set of required sources. In this example, if a topic of a topic node is not connected to one data object node from a specified set of required sources, for example, the topic of the topic node is only connected to data object nodes from an e-mail source and a meeting source, but the specified set of required sources requires a document source, the e-mail source and a meeting source, the topic node can be removed.

In some embodiments, settings may be presented in a user interface to independently turn on or off each of one or more of the embodiments and examples of preprocessing the knowledge graph by user knowledge graph preprocessor component 260 described above through configuration settings presented to the user.

Some embodiments of user knowledge graph preprocessor component 260 utilize user knowledge graph preprocessor logic 265 stored in storage 225 to preprocess the user knowledge graph. In particular, user knowledge graph preprocessor logic 265 may comprise computer instructions including rules, conditions, associations, classification models, or other criteria for, among other operations, to preprocess the user knowledge graph. User knowledge graph preprocessor logic 265 may take different forms, depending on the particular preprocessing of the knowledge graph. For example, user knowledge graph preprocessor logic 265 may comprise a set of rules, such as Boolean logic, various decision trees (e.g., random forest, gradient boosted trees, or similar decision algorithms), conditions or other logic, fuzzy logic, neural network, finite state machine, support vector machine, machine-learning techniques, or combinations of these to preprocess the user knowledge graph according to embodiments described herein.

Continuing with FIG. 2, candidate topics identifier component 270, including its subcomponents contact subgraph generator component 272, candidate topics processor component 274, and candidate topics ranking component 276, is generally responsible for to infer a set of candidate topics for a particular contact from a knowledge graph of a user. Embodiments of candidate topics identifier component 270 may to infer a set of candidate topics for the particular contact based on a user knowledge graph data generated by user knowledge graph generator component 250 and/or preprocessed by user knowledge graph preprocessor component 260. Thus, information regarding the user knowledge graph generated by user knowledge graph generator component 250 and/or preprocessed by user knowledge graph preprocessor component 260 may be accessed by candidate topics identifier component 270 (including its subcomponents) in storage 225. The data generated by candidate topics identifier component 270 (including its subcomponents) may be stored storage 225, where it may be used by other components or subcomponents of system 200.

Embodiments of candidate topics identifier component 270, through contact subgraph generator component 272, may generate a subgraph of the knowledge for each contact in order to identify and prune the topics of the topics nodes within the subgraph for the particular contact to infer a set of candidate topics for the particular contact. In this regard, important topics the user collaborated on with each of their contacts can be inferred from a sub-graph of the user's graph containing only the nodes connected with the particular contact node of the contact, thereby reducing noise from other nodes/edges. One example of such a subgraph of a knowledge graph generated for each contact is further described in connection with FIG. 3B. In some embodiments, identifying and pruning the topics for each contact within the subgraph for the contact by candidate topics identifier component 270 occurs after preprocessing the knowledge graph.

In some embodiments, candidate topics identifier component 270, through candidate topics processor component 274, may determine the topics for each contact within the subgraph for the contact includes ranking each topic node in order of importance and selecting the top N number of topics from the topic nodes above a threshold ranking. For example, for each contact through a corresponding subgraph for the contact, up to N top ranked topics from the topic nodes of the subgraph using a PageRank algorithm. As an example, the PageRank algorithm may include alpha=0.5 and a maximum number of 5 iterations.

In some embodiments, candidate topics identifier component 270, through candidate topics processor component 274, prunes the topics for each contact within the subgraph for the contact includes clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated. In some instances, performing clustering for the subgraph of the contact is less computationally expensive than during preprocessing the knowledge graph as there likely is a smaller number of topics.

In some embodiments, after clustering and merging topics, the process of identifying the topics for each contact within the subgraph for the contact by ranking each topic node in order of importance and selecting the top N number of topics from the topic nodes above a threshold ranking is repeated by candidate topics identifier component 270 through candidate topics processor component 274.

In some embodiments, candidate topics identifier component 270, through candidate topics processor component 274, prunes the topics for each contact within the subgraph for the contact includes removing topics inferred for more than a given percentage of contacts. For example, if a topic was identified for more than 50% of contacts, the topic is removed. As a more specific example, if all of the user's contacts belong to the same team, named “The A-Team,” every contact may get a topic inferred corresponding to the “The A-Team,” which would not necessarily be information for collaboration between the user and the specific contact.

In some embodiments, for each contact sub-graph, candidate topics identifier component 270, through candidate topics processor component 274, prunes the topics for each contact within the subgraph for the contact includes repeating reducing the number of topic of the topic nodes by merging topics, removing topics contained within other topics, and/or any other process of the knowledge graph preprocessing described in connection with user knowledge graph preprocessor component 260. In some embodiments, candidate topics identifier component 270, through candidate topics processor component 274, repeats each of the reducing the number of topic of the topic nodes by merging topics, removing topics contained within other topics, and/or any other process of the knowledge graph preprocessing described in connection with user knowledge graph preprocessor component 260 for each subgraph of each contact after removing topics inferred for more than a given percentage of contacts.

In some embodiments, for each candidate topic inferred (for example, after identifying and pruning the topics of the topics nodes for each contact within the subgraph for the particular contact to infer a set of candidate topics for the particular contact by candidate topics identifier component 270), candidate topics identifier component 270, through candidate topics ranking component 276, computes (1) the number of data object nodes connected to each topic and/or (2) the total weight of all edges from the topic node to the data object nodes (referred to herein as “topic frequency”).

In some embodiments, candidate topics identifier component 270, through candidate topics ranking component 276, ranks the set of candidate topics inferred for each contact. For example, candidate topics identifier component 270, through candidate topics ranking component 276, may rank each candidate topic in the set of candidate topics based on frequency of occurrence between the user and a contact. For instance, some embodiments utilize term frequency-inverse document frequency (“tf-idf”), term frequency*proportional document frequency (“tf*pdf”) and/or any related algorithm. As another example, candidate topics identifier component 270, through candidate topics ranking component 276, ranks the identified and pruned topics for each contact according to the topic frequency and/or the number of content nodes connected to the topic node of the topic. In some embodiments, candidate topics ranking component 276 ranks candidate topics based on recency, such as how recently was the topic occurrence in communications between the user and a contact. Some embodiments of candidate topics ranking component 276 rank candidate topics based on the number of different data sources in which the topics occur. For example a topic occurring in various communication channels between a user and a contact, such as email, chat, meeting transcripts, document comments, or other sources, would have a higher ranking than a topic that occurs only in a single source, such as only occurring in email. In some embodiments, candidate topics may be weighted or ranked based on a predetermined importance or weighting. For example, a user or an administrator may explicitly indicate certain topics, such as topics relevant to an organization, company, or project, are to be prioritized and thus receive a higher ranking (or a higher weighting thereby resulting in a higher ranking.) Some embodiments utilize a combination of these criteria for ranking candidate topics.

Some embodiments of candidate topics identifier component 270, including its subcomponents contact subgraph generator component 272, candidate topics processor component 274, and candidate topics ranking component 276, utilize candidate topics identifier logic 275, stored in storage 225, to infer or otherwise determine a set of candidate topics for a particular contact from a knowledge graph of a user. In particular, candidate topics identifier logic 275 may comprise computer instructions including rules, conditions, associations, classification models, or other criteria for, among other operations, to infer a set of candidate topics for a particular contact from a knowledge graph of a user, or any of the embodiments described herein. Candidate topics identifier logic 275 may take different forms, depending on the particular information items being determined, extracted, and/or processed. For example, candidate topics identifier logic 275 may comprise a set of rules, such as Boolean logic, various decision trees (e.g., random forest, gradient boosted trees, or similar decision algorithms), conditions or other logic, fuzzy logic, neural network, finite state machine, support vector machine, machine-learning techniques, or combinations of these to infer (facilitate inferring) a set of candidate topics for a particular contact from a knowledge graph of a user according to embodiments described herein.

Example system 200 includes a presentation component 280 that is generally responsible for presenting topics for each contact as inferred by candidate topics identifier component 270 (including its subcomponents). The topics for each contact may be presented via one or more presentation components 816, as described in FIG. 8. Presentation component 280 may comprise one or more applications or services on a user device across multiple user devices or in the cloud. For example, presentation component 280 may determine on which user device(s) topics for each contact is presented based on the user(s) of the user device(s) and how or how much content is presented, and may present data generated by other components of system 200. In some embodiments, presentation component 280 can present topic data for each contact, proactively and dynamically, such as when in response to a user interacting with a contact or an indication of the contact, or a user interacting with or an indication of GUI element for topic information for each contact, or for instance, where a contact joins an online meeting or enters a chat session with the user. For example, presentation component 280 may determine when, whether, and how to present topic data for each contact based on presentation logic.

Some embodiments of presentation component 280 can determine how many topics, if any, should be presented for a particular contact to a user. Alternatively, presentation logic may specify for presentation component 280, or may instruct presentation component 280 how many topics, if any, should be presented for a particular contact to a user. This determination can be made, for example, based upon the user device's screen size (with potentially more or differently formatted topics for each contact presentable on, for instance, a laptop computer, as compared to a mobile phone) or the surface on which the topics for a particular contact will be presented (for example, a calendaring application, communication platform, or other application or program) such as described previously. The presentation component 280 can present, via a GUI, in a number of different formats and applications, such as the example shown in FIG. 4 (discussed further below). Presentation component 280 may also generate user interface features associated with or used to facilitate presenting topics for each contact. Such features can include interface elements (such as icons or indicators, graphics buttons, sliders, menus, audio prompts, alerts, alarms, vibrations, pop-up windows, notification-bar or status-bar items, in-app notifications, or other similar features for interfacing with a contact), queries, and prompts.

In some embodiments, presentation component 280 can cause presentation of a preset number of topics for each contact to the user from the set of candidate topics generated by candidate topics identifier component 270, through candidate topics ranking component 276, and stored in storage 225. For example, presentation component 280 can cause presentation of a ranked set of topic information items for each contact (or a portion thereof) by assembling and formatting or preparing for presentation to the user via a GUI element, which may be modified to depict information regarding the topics for each contact.

In this regard, one or more topics for a certain contact (or multiple contacts) can be presented to the user by presentation component 280 to facilitate communication with the certain contact or contacts regarding the one or more topics. For example, when a user navigates to a certain contact, a topic for the certain contact can be presented to the user by presentation component 280 via a GUI. In some embodiments, multiple topics are presented, and further the topics may be ordered such ranked according to frequency of the topics occurrence, as described herein. When the user communicates with the certain contact, such as by call, text, chat, message, email, or other communication, the user can address the topic or topics in the user's communication to the certain contact without having to manually determine the most relevant topics between the user and the certain contact. As another example, when a user has a meeting scheduled with a certain contact, one or more topics relevant to the certain contact can be presented to the user by presentation component 280 via a GUI. In some embodiments a plurality of topics are presented as a ranked or ordered list of topics. For example, as described herein, the topics may be ranked based on frequency of occurrence between the user and certain contact, based on recency, based on the number of different data sources in which the topics occur, a combination of these or another criterion. The user can address a topic during the meeting with the certain contact without having to manually identify the most relevant topics between the user and the certain contact. As still another example, when a user receives a communication from a certain contact, one or more topics for the certain contact can be presented to the user by presentation component 280 via a GUI. When the user responds to the communication with the certain contact, such as by call, text, chat, message, email, or the like, the user can address the topics, or a portion thereof, in the user's response to the certain contact without having to manually identify the topics between the user and the certain contact.

In some embodiments, a user or a third party can display topics between two or more other users through presentation component 280. For example, a user can approve the display of topics between the user and contacts of the user in order to display the topics to a different user or a third party through presentation component 280. For example, a user discusses a certain project frequently with other contacts and wishes to share the topic between the user and the other contacts with a third party or a different user. In this regard, the topic between the user and their contacts can be shared with the different user or third party. In some embodiments, the user can select a setting in a user interface whether to share topics between the user and the user's contacts with a different user or third party for privacy considerations.

With reference now to FIGS. 3A and 3B, example diagrams of example knowledge graphs that are utilized to identify topics between a user and each contact of the user are illustratively depicted, in accordance with embodiments of the present disclosure. The node and edge data shown in FIGS. 3A and 3B can be utilized to identify topics between a user and each contact of the user, such as described in connection with the components of system 200 of FIG. 2. The generating of the example node and edge data, as well as the preprocessing of the example node and edge data, and generating of subgraphs for each contact may be determined as described in connection with, for example, user knowledge graph generator component 250, user knowledge graph preprocessor component 260, and candidate topics identifier component 270 through its subcomponent, contact subgraph generator component 272, of FIG. 2.

With reference now to FIG. 3A, an example diagram 300A of an example knowledge graph is illustratively depicted. As can be understood, a knowledge graph for a specific user depicted in example diagram 300A corresponds to the collaboration of the user and each of their contacts through various applications or platforms can be stored and accessed. For example, a knowledge graph for a user depicted in example diagram 300A can be generated and stored as described with respect to user knowledge graph generator component 250 and/or user knowledge graph preprocessor component 260 of FIG. 2. The knowledge graph includes nodes corresponding to contacts of the user, data objects that the user has interacted with, and topics extracted from the data objects. As shown, nodes corresponding to contacts of the user include contact 302 and contact 2 322. Nodes corresponding to data objects that the user has interacted with include document 1 306, email 2 310, email 1 332, and chat 1 328. Nodes corresponding to the topics extracted from the data objects include (1) topic 1 312, which is extracted from document 1 306 and e-mail 2 318, (2) topic 2 314, which is extracted from document 1 306, (3) topic 3 334, which is extracted from chat 1 328, and (4) topic 4 336, which is extracted from e-mail 1 332 and chat 1 328. As can be understood, each of the topics 312, 314, 334, and 336 were extracted from the data objects by a language model and correspond to keywords (or key phrases) identified in the data objects, such as groups, projects, events, organizations, locations, products, etc.

As can be understood from FIG. 3A, the knowledge graph also includes edges corresponding to relationships between the contacts and the data objects and relationships between the data objects and the topics. As shown in FIG. 3A, the edges corresponding to relationships between the data objects and the topics correspond to which data objects the keywords were extracted from. The edges corresponding to relationships between the contacts and the data objects correspond to interactions between the contacts and the data objects. Further, data stored with respect to edge 304 indicates that contact 1 302 opened document 1 306. Data stored with respect to edge 308 indicates contact 1 302 read e-mail 2. Data stored with respect to edge 326 indicates that contact 2 322 commented in chat 1 328. Data stored with respect to edge 330 indicates that contact 322 responded to e-mail 1 332.

Further, as shown in FIG. 3A, features corresponding to the specific user's (the specific user for which the knowledge graph is generated for) interactions with the data object may be stored in relation to the data object node, such as through metadata of the data object node As depicted, feature 316 corresponding to the specific user's interactions with document 1 306 stored in relation to document 1 306 indicates that the specific user modified document 1 306. Feature 318 corresponding to the specific user's interactions with e-mail 2 310 stored in relation to e-mail 2 310 indicates that the specific user responded to e-mail 2 310. Feature 338 corresponding to the specific user's interactions with chat 1 328 stored in relation to chat 1 328 indicates that the specific user commented in chat 1 328. Feature 340 corresponding to the specific user's interactions with e-mail 1 332 stored in relation to e-mail 1 332 indicates that the specific user responded to e-mail 1 332.

With reference now to FIG. 3B, an example diagram 300B of an example knowledge graph is illustratively depicted showing example diagram 300A of FIG. 3A with subgraphs for each of the contacts. As can be understood, the knowledge graph for the specific user depicted in example diagram 300B corresponds to the collaboration of the user and each of their contacts through various applications or platforms can be stored and accessed. For example, the knowledge graph for the user depicted in example diagram 300B can be generated and stored as described with respect to user knowledge graph generator component 250, user knowledge graph preprocessor component 260, and candidate topics identifier component 270 through its subcomponent, contact subgraph generator component 272, of FIG. 2.

As can be understood with respect to FIG. 3B, a subgraph of the knowledge is generated for each contact. As shown, contact 1 subgraph 320 corresponds to the nodes associated with contact 1 302 and contact 2 subgraph 342 corresponds to the nodes associated with contact 2 322. The subgraphs 320 and 342 for each contact can be used to identify and prune the topics of the topics nodes within the subgraph for the particular contact to infer a set of candidate topics for the particular contact as described in embodiments herein. In this regard, important topics the user collaborated on with each of their contacts can be inferred from a sub-graph of the user's graph containing only the nodes connected with the particular contact node of the contact, thereby reducing noise from other nodes/edges.

With reference now to FIG. 4, an example schematic screenshot from a personal computing device is illustratively depicted, showing aspects of an example graphical user interface that include presentation of topics identified between a user and each contact of the user, as described herein. The topic data as shown in FIG. 4 may be determined for each contact of a user, such as described in connection with the components of system 200 of FIG. 2. The example topic data identified for each contact of a user, as well as the formatting, assembly, or presentation may be determined as described in connection presentation component 280 of FIG. 2.

With reference to FIG. 4, an example screen display 400 is shown, which may be presented via a computing device, such as user device 102n, discussed above with respect to FIG. 1. Example screen display 400 depicts a GUI showing aspects of topics 404 that can be displayed with respect to contacts 406, 408, and 410 of a user. This example screen display 400 may be presented to a user viewing another person that the user has interacted with, such as the user's contacts, which may be presented via an address book application, a directory or organizational explorer application, a communication application such as an email, messaging, or meeting application, social media platform accessed via a browser, or a corporate intranet or company profile page for the specific user.

As shown in example screen display 400, topics 407, 409, and 411 are inferred for each of the contacts 406, 408, and 410, respectively, and are included along with the contacts 406, 408, and 410. The topics 407, 409, and 411 for each contact can be inferred through embodiments described herein. For example, topics 407 inferred for contact “Runa Smith” 406 include “Quarterly Sales Update Meeting,” “New Product Launch,” and “California.” Topics 409 inferred for contact “Aleksander Myrvold” 408 include “Project Timeline Update” and “Compliance Requirements.” Topics 411 inferred for contact “Jeanine Green” 410 include “Sales Pipeline for New Product” and “Quarterly Sales Update Meeting.”

Turning now to FIGS. 5, 6, and 7, aspects of an example process flows 500, 600, and 700 are illustratively depicted for some embodiments of the disclosure. Process flows 500, 600, and 700 each may comprise a method (sometimes referred to herein as method 500, method 600, and method 700) that may be carried out to implement various example embodiments described herein. For instance, process flow 500, process flow 600, or process flow 700 may be performed to programmatically identify topics between a user and each contact of the user using a knowledge graph, which may be used to provide any of the improved electronic communications technology or enhanced user computing experiences described herein.

Each block or step of process flow 500, process flow 600, process flow 700, and other methods described herein comprises a computing process that may be performed using any combination of hardware, firmware, and/or software. For instance, various functions may be carried out by a processor executing instructions stored in memory, such as memory 812 described in FIG. 8 and/or storage 225 described in FIG. 2. The methods may also be embodied as computer-usable instructions stored on computer storage media. The methods may be provided by a stand-alone application, a service or hosted service (stand-alone or in combination with another hosted service), or a plug-in to another product, to name a few. The blocks of process flow 500, 600, and 700 that correspond to actions (or steps) to be performed (as opposed to information to be processed or acted on) may be carried out by one or more computer applications or services, in some embodiments, which may operate on one or more user devices (such as user device 102a), servers (such as server 106), and may be distributed across multiple user devices, and/or servers, or by a distributed computing platform, and/or may be implemented in the cloud, such as described in connection with FIG. 9. In some embodiments, the functions performed by the blocks or steps of process flows 500, 600, and 700 are carried out by components of system 200, described in connection to FIG. 2.

With reference to FIG. 5, aspects of example process flow 500 are illustratively provided for programmatically identifying topics between a user and each contact of the user using a knowledge graph. In particular, example process flow 500 may be performed to generate topic data for each contact of a particular user, as described in connection with FIG. 2.

At block 510, method 500 includes accessing a knowledge graph for a user where the knowledge graph includes (1) nodes corresponding to (a) contacts of the user, (b) data objects of the user, and (c) topics extracted from the data objects and (2) edges corresponding to (a) interactions between the contacts and the data objects and (b) relationships between the data objects and the topics.

Some embodiments of block 510 comprise generating a knowledge graph for a user corresponding to the collaboration of the user and each of their contacts through various applications or platforms can be stored and accessed. Each of the contacts nodes of knowledge graph correspond to the contacts of the user may be contacts from a user's contact list from a particular communications application or platform, a network of contacts from a particular communications application or platform (for example, people from a particular organization or group within the particular organization), and/or contacts included on various communications or documents, such as e-mail threads, chat conversations, meetings, within documents or an edit history of the document, etc. Each of the data object nodes of the knowledge graph corresponding to data objects that the user has interacted with may include various communications or documents, such as e-mail threads, chat conversations, meetings, documents, etc. In this regard, the edges corresponding to relationships between the contacts and the data objects correspond to interactions between the contacts and the data objects. For example, an edge may indicate whether a particular contact has read or responded to an E-mail, whether a particular contact has opened or modified a document, whether a particular contact has read or commented in a chat, etc. Each of the topics extracted from the data objects can correspond to keywords (or key phrases) identified in the data objects by a language model, such as groups, projects, events, organizations, locations, products, etc. In this regard, the edges corresponding to relationships between the data objects and the topics correspond to which data objects the keywords were extracted from.

Some embodiments of block 510 comprise a knowledge graph comprising features corresponding to the user's interactions with the data object may be stored in relation to the data object node, such as through metadata of the data object node. For example, features stored in relation to the data object node may indicate whether the user has read or responded to an E-mail, whether the user has opened or modified a document, whether the user has read or commented in a chat, etc.

Some embodiments of block 510 comprise a knowledge graph where each of the nodes of the knowledge graph are ranked by the importance of each node, which is correlated with how many edges are connected to the node. For example, a contact node connected by edges to more data object nodes, which indicates that the contact interacted with more than one data object with the user, will be ranked higher than a contact node connected by edges to less data object nodes. As another example, a data object node connected by edges to more contact nodes, which indicates more than one contact has interacted with the data object, will be ranked higher than a data object node connected by edges to less contact nodes. As another example, a topic node connected by edges to more data object nodes, which indicates that the topic of the topic node was identified in more than one data object, will be ranked higher than a topic node connected by edges to less data object nodes. Some embodiments of block 510 comprise a knowledge graph where the edges include edge weights to indicate the strength of the relationship which can be used to rank the importance of each node. For example, an edge between a topic node and data object node can have a larger edge weight when the topic of the topic node is mentioned more frequently in the data object of the data object node. In this regard, the topic node and/or data object node can be ranked higher based on the larger edge weight. As another example, an edge between a data object node and a contact node can have a larger edge weight when there are more interactions between the contact of the contact node and the data object of the data object node. In this regard, the contact node and/or data object node can be ranked higher based on the larger edge weight.

Embodiments of block 510 may be carried out using topic extractor component 240 (FIG. 2), user knowledge graph generator component 250 (FIG. 2), and/or data collection component 230 (FIG. 2), in some implementations. Additional details of embodiments of block 510, or for carrying out operations of block 510, are described in connection to FIG. 2, and in particular user knowledge graph generator component 250 and data collection component 230. Moreover, examples of knowledge graphs that are utilized to identify topics between a user and each contact of the user according to some embodiments of block 510 are illustratively depicted in FIGS. 3A and 3B and described further in connection with the drawings.

At block 520, method 500 includes preprocessing the knowledge graph to prune contacts and topics. Some embodiments of block 520 comprise preprocessing the knowledge graph in order to prune contact nodes, data object nodes, and/or topic nodes. In this regard, the preprocessing of the knowledge graph reduces the size of data to be processed by narrowing down the amount of contacts for which topics are inferred, narrowing down the amount of data objects from the which the topics of are inferred, and narrowing down the amount of topics to remove “noisy” data that may lower the quality of the final result. Some embodiments of block 520 comprise pruning and pre-processing being performed on the entire graph simultaneously.

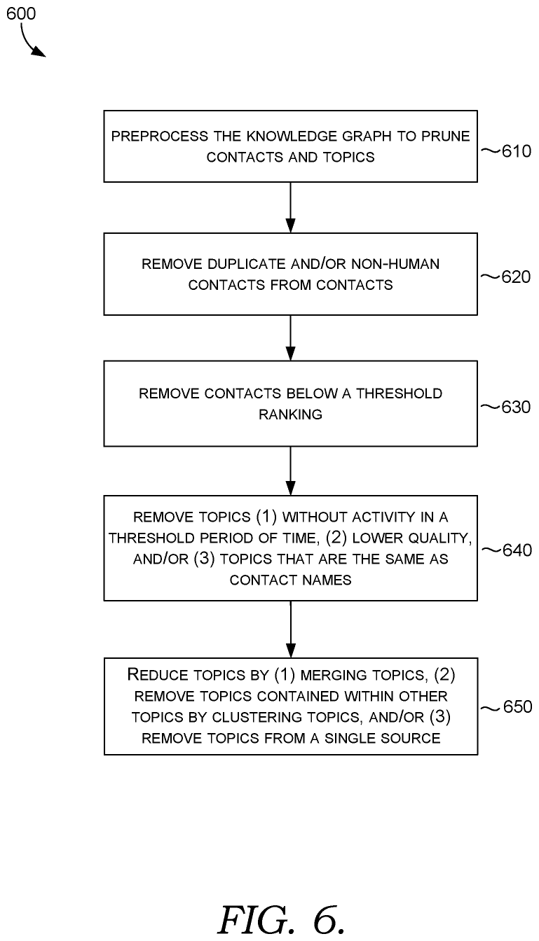

Embodiments of block 520 may be carried out using user knowledge graph preprocessor component 260 (FIG. 2), in some implementations. Additional details of embodiments of block 520, or for carrying out operations of block 520, are described in connection to FIG. 2, and in particular user knowledge graph preprocessor component 260. Moreover, embodiments of block 520 are described in further detail with respect to FIG. 6.

At block 530, method 500 includes identifying and pruning topics for each contact in subgraphs of the knowledge graph for each contact. Some embodiments of block 530 comprise generating a subgraph of the knowledge graph for each contact in order to identify and prune the topics of the topics nodes within the subgraph for the particular contact and to infer a set of candidate topics for the particular contact. In this regard, important topics the user collaborated on with each of their contacts can be inferred from a sub-graph of the user's graph containing only the nodes connected with the particular contact node of the contact, thereby reducing noise from other nodes/edges. Some embodiments of block 530 comprise identifying and pruning the topics for each contact within the subgraph for the contact only after preprocessing the knowledge graph.

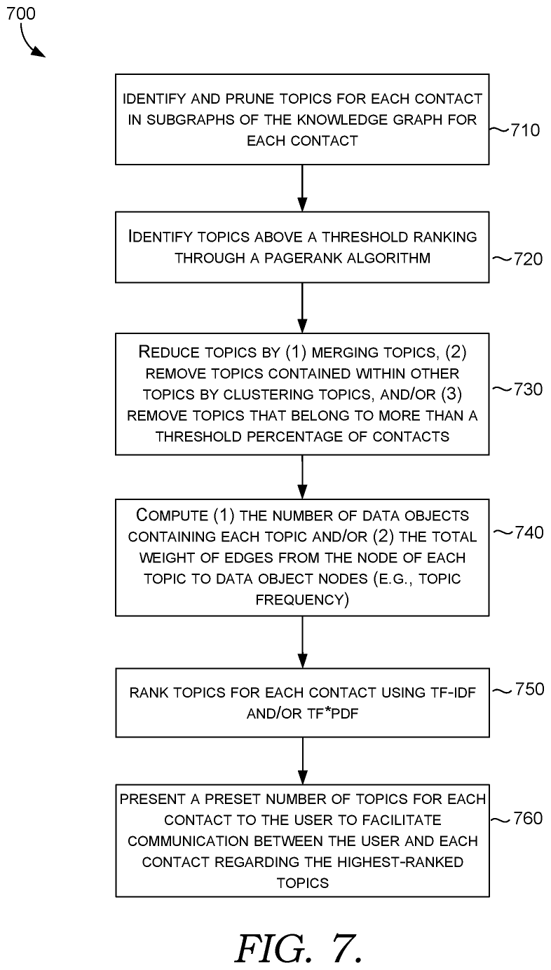

Embodiments of block 530 may be carried out using candidate topics identifier component 270 (FIG. 2), in some implementations. Additional details of embodiments of block 530, or for carrying out operations of block 530, are described in connection to FIG. 2, and in particular candidate topics identifier component 270. Moreover, embodiments of block 530 are described with respect to FIG. 7. Even further, an example of subgraphs of a knowledge graphs generated for each contact that are utilized to identify topics between a user and each contact of the user according to some embodiments of block 530 are illustratively depicted in FIG. 3B and described further in connection with the drawings.

At block 540, method 500 includes presenting one or more topics for a certain contact (or multiple contacts) to the user to facilitate communication with the certain contact or contacts regarding the one or more topics. For example, when a user navigates to a certain contact, a topic for the certain contact can be presented to the user via a GUI. In some embodiments, multiple topics are presented, and further the topics may be ordered such ranked according to a criterion such as the frequency of the topic's occurrence, as described herein. When the user communicates with the certain contact, such as by call, text, chat, message, email, or other communication, the user can address the topic or topics in the user's communication to the certain contact without having to manually determine the most relevant topics between the user and the certain contact. As another example, when a user has a meeting scheduled with a certain contact, one or more topics relevant to the certain contact can be presented to the user via a GUI. In some embodiments a plurality of topics are presented as a ranked or ordered list of topics. For example, as described herein, the topics may be ranked based on frequency of occurrence between the user and certain contact, based on recency, based on the number of different data sources in which the topics occur, a combination of these or another criterion. The user can address a topic during the meeting with the certain contact without having to manually identify the most relevant topics between the user and the certain contact. As still another example, when a user receives a communication from a certain contact, one or more topics for the certain contact can be presented to the user via a GUI. When the user responds to the communication with the certain contact, such as by call, text, chat, message, email, or the like, the user can address the topics, or a portion thereof, in the user's response to the certain contact without having to manually identify the topics between the user and the certain contact

Some embodiments of block 540 comprise that the set of candidate topics inferred for each contact are ranked. For example, each candidate topic in the set of candidate topics can be ranked using term frequency-inverse document frequency (“tf-idf”), term frequency*proportional document frequency (“tf*pdf”) and/or any related algorithm. As another example, the identified and pruned topics for each contact are ranked according to the topic frequency and/or the number of content nodes connected to the topic node of the topic.

Some embodiments of block 540 comprise a preset number of topics for each contact is presented to the user from the ranked set of candidate topics. For example, a set of topic information items for each contact (or a portion thereof) may be assembled and formatted or prepared for presentation to the user via a GUI element, which may be modified to depict information regarding the topics for each contact.

Embodiments of block 540 may be carried out using candidate topics identifier component 270 (FIG. 2) and presentation component 280 (FIG. 2), in some implementations. Additional details of embodiments of block 540, or for carrying out operations of block 540, are described in connection to FIG. 2, and in particular candidate topics identifier component 270 and presentation component 280. Moreover, embodiments of block 540 are described with respect to FIG. 7. Even further, an example of topics identified for each contact of a user provided for presentation according to some embodiments of block 540 are illustratively depicted in FIG. 4 and described further in connection with the drawing.

With reference to FIG. 6, aspects of example process flow 600 are illustratively provided for programmatically identifying topics between a user and each contact of the user using a knowledge graph. In particular, example process flow 600 may be performed to generate topic data for each contact of a particular user, as described in connection with FIG. 2 and example process flow 600 provides further embodiments with respect to block 520 of FIG. 5.

At block 610, method 600 includes preprocessing the knowledge graph to prune contacts and topics. Embodiments of block 610 are described in connection to block 520 of FIG. 5. Embodiments of block 610 may be carried out using user knowledge graph preprocessor component 260 (FIG. 2), in some implementations. Additional details of embodiments of block 610, or for carrying out operations of block 610, are described in connection to FIG. 2, and in particular user knowledge graph preprocessor component 260.

At block 620, method 600 includes removing duplicate and/or non-human contacts from contacts. Some embodiments of block 620 comprise preprocessing the knowledge graph in order to prune contact nodes by removing (1) duplicate contacts (for example, the same person known via different e-mail addresses) and/or (2) non-human contacts (for example, distribution lists, automated accounts, etc.). Embodiments of block 620 may be carried out using user knowledge graph preprocessor component 260 (FIG. 2), in some implementations. Additional details of embodiments of block 620, or for carrying out operations of block 620, are described in connection to FIG. 2, and in particular user knowledge graph preprocessor component 260.

At block 630, method 600 includes removing contacts below a threshold ranking. Some embodiments of block 630 comprise preprocessing the knowledge graph in order to prune contact nodes by ranking each contact node in order of importance and selecting the top N number of contacts or contacts above a threshold ranking. Embodiments of block 630 may be carried out using user knowledge graph preprocessor component 260 (FIG. 2), in some implementations. Additional details of embodiments of block 630, or for carrying out operations of block 630, are described in connection to FIG. 2, and in particular user knowledge graph preprocessor component 260.

At block 640, method 600 includes removing topics (1) without activity in a threshold period of time, (2) lower quality, and/or (3) topics that are the same as contact names. Some embodiments of block 640 comprise preprocessing the knowledge graph in order to prune data object nodes and/or topic nodes connected to the data object nodes by removing data object nodes without activity within a threshold period of time. For example, a data object node corresponding to a chat without activity in N number of days may be removed along with any topic nodes connected to the data object node of the chat. Some embodiments of block 640 comprise preprocessing the knowledge graph in order to prune topic nodes by removing (1) topic nodes connected to data object nodes without activity within a threshold period of time, (2) selected types of topics for topic nodes which are particularly noisy and lower quality (for example, the topics of the topic nodes were generated by less accurate topic extraction models), and/or (3) topics that are the same as contact names. Embodiments of block 640 may be carried out using user knowledge graph preprocessor component 260 (FIG. 2), in some implementations. Additional details of embodiments of block 640, or for carrying out operations of block 640, are described in connection to FIG. 2, and in particular user knowledge graph preprocessor component 260.

At block 650, method 600 includes reducing topics by (1) merging topics, (2) remove topics contained within other topics by clustering topics, and/or (3) remove topics from a single source.

Some embodiments of block 650 comprise preprocessing the knowledge graph in order to prune topic nodes by reducing the number of topic of the topic nodes by merging topics. For example, topics can be merged by merging multiples of a topic. In this regard, separate topics may be extracted from a data object(s) and stored as different topic nodes in the knowledge graph, but the topics may be variations of the same topic. As an example, triples of a topic with more than one word (for example, “team,” “product 1,” and “product 1 team”) may be extracted from a data object and stored as separate topics in separate topic nodes of the knowledge graph. In this regard, the separate topics in the separate topic nodes can be merged into a single topic of the longest length (in the example above, “product 1 team”). In some embodiments, topics are merged only if the maximum Jaccard distance between any pair of the sets of data objects of the data object nodes containing each topic is below a certain threshold.

Some embodiments of block 650 comprise preprocessing the knowledge graph in order to prune topic nodes by removing topics contained within other topics by clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated.

Some embodiments of block 650 comprise preprocessing the knowledge graph in order to prune topic nodes by removing topics from a single source. In this example, if a topic of a topic node is only connected to a data object nodes from a single source, such as only from calendar meetings, only in e-mails, only in text messages, only in documents, etc., the topic node can be removed. As another example, the knowledge graph can be preprocessed in order to prune topic nodes by removing topics which are not present in a specified set of required sources. In this example, if a topic of a topic node is not connected to one data object node from a specified set of required sources, for example, the topic of the topic node is only connected to data object nodes from an e-mail source and a meeting source, but the specified set of required sources requires a document source, the e-mail source and a meeting source, the topic node can be removed.

Some embodiments of block 650 comprise preprocessing the knowledge graph by presenting settings in a user interface to independently turn on or off each of one or more of the embodiments and examples of preprocessing the knowledge graph described above through configuration settings presented to the user.

Embodiments of block 650 may be carried out using user knowledge graph preprocessor component 260 (FIG. 2), in some implementations. Additional details of embodiments of block 650, or for carrying out operations of block 650, are described in connection to FIG. 2, and in particular user knowledge graph preprocessor component 260.

With reference to FIG. 7, aspects of example process flow 700 are illustratively provided for programmatically identifying topics between a user and each contact of the user using a knowledge graph. In particular, example process flow 700 may be performed to generate topic data for each contact of a particular user, as described in connection with FIG. 2 and example process flow 700 provides further embodiments with respect to block 530 and 540 of FIG. 5.

At block 710, method 700 includes identifying and pruning topics for each contact in subgraphs of the knowledge graph for each contact. Embodiments of block 710 are described in connection to block 530 of FIG. 5. Embodiments of block 710 may be carried out using candidate topics identifier component 270 (FIG. 2), in some implementations. Additional details of embodiments of block 710, or for carrying out operations of block 710, are described in connection to FIG. 2, and in particular candidate topics identifier component 270.

At block 720, method 700 includes identifying topics above a threshold ranking through a PageRank algorithm. Some embodiments of block 720 comprise identifying the topics for each contact within the subgraph for the contact by ranking each topic node in order of importance and selecting the top N number of topics from the topic nodes above a threshold ranking. For example, for each contact through a corresponding subgraph for the contact, up to N top ranked topics from the topic nodes of the subgraph using a PageRank algorithm. As an example, the PageRank algorithm may include alpha=0.5 and a maximum number of 5 iterations. Embodiments of block 720 may be carried out using candidate topics identifier component 270 (FIG. 2), in some implementations. Additional details of embodiments of block 720, or for carrying out operations of block 720, are described in connection to FIG. 2, and in particular candidate topics identifier component 270.

At block 730, method 700 includes reducing topics by (1) merging topics, (2) remove topics contained within other topics by clustering topics, and/or (3) remove topics that belong to more than a threshold percentage of contacts. Some embodiments of block 730 comprise pruning the topics for each contact within the subgraph for the contact by clustering topics by their Levenshtein distance, merging the clustered topics, and leaving only the highest ranked topic in the cluster. For example, for two topics with a Levenshtein distance below a threshold value and stored in two separate topic nodes corresponding to the topics of “team” and “product 1 team,” and assuming the topic node corresponding to “product 1 team,” was ranked as more important the topic node corresponding to “team,” the topic node for the topic of “team” would be removed. In some embodiments, topics from trusted sources are ranked higher than topics from less trusted sources. In some embodiments, when there are only topics from less trusted sources, the highest ranked topic is chosen. In some embodiments, an agglomerative clustering algorithm is chosen as a clustering method to minimize the number of Levenshtein distances calculated. In some instances, performing clustering for the subgraph of the contact is less computationally expensive than during preprocessing the knowledge graph as there likely is a smaller number of topics.

Some embodiments of block 730 comprise repeating, after clustering and merging topics, the process of identifying the topics for each contact within the subgraph for the contact by ranking each topic node in order of importance and selecting the top N number of topics from the topic nodes above a threshold ranking. Some embodiments of block 730 comprise pruning the topics for each contact within the subgraph for the contact by removing topics inferred for more than a given percentage of contacts. For example, if a topic was identified for more than 50% of contacts, the topic is removed. As a more specific example, if all of the user's contacts belong to the same team, named “The A-Team,” every contact may get a topic inferred corresponding to the “The A-Team,” which would not necessarily be information for collaboration between the user and the specific contact.

Some embodiments of block 730 comprise, for each contact sub-graph, pruning the topics for each contact within the subgraph for the contact by repeating reducing the number of topic of the topic nodes by merging topics, removing topics contained within other topics, and/or any other process of the knowledge graph preprocessing of FIG. 6. Some embodiments of block 730 comprise repeating reducing the number of topic of the topic nodes by merging topics, removing topics contained within other topics, and/or any other process of the knowledge graph preprocessing of FIG. 6 for each subgraph of each contact after removing topics inferred for more than a given percentage of contacts.

Embodiments of block 730 may be carried out using candidate topics identifier component 270 (FIG. 2), in some implementations. Additional details of embodiments of block 730, or for carrying out operations of block 730, are described in connection to FIG. 2, and in particular candidate topics identifier component 270.

At block 740, method 700 includes computing (1) the number of data objects containing each topic and/or (2) the total weight of edges from the node of each topic to data object nodes (e.g., topic frequency). Some embodiments of block 740 comprise computing, for each candidate topic inferred (for example, after identifying and pruning the topics of the topics nodes for each contact within the subgraph for the particular contact to infer a set of candidate topics for the particular contact), (1) the number of data object nodes connected to each topic and/or (2) the total weight of all edges from the topic node to the data object nodes (referred to herein as “topic frequency”).

Embodiments of block 740 may be carried out using candidate topics identifier component 270 (FIG. 2), in some implementations. Additional details of embodiments of block 740, or for carrying out operations of block 740, are described in connection to FIG. 2, and in particular candidate topics identifier component 270.

At block 750, method 700 includes ranking topics for each contact using tf-idf and/or tf*pdf. Some embodiments of block 750 comprise that the set of candidate topics inferred for each contact are ranked. For example, each candidate topic in the set of candidate topics can be ranked using term frequency-inverse document frequency (“tf-idf”), term frequency*proportional document frequency (“tf*pdf”) and/or any related algorithm. As another example, the identified and pruned topics for each contact are ranked according to the topic frequency and/or the number of content nodes connected to the topic node of the topic.

Embodiments of block 750 may be carried out using candidate topics identifier component 270 (FIG. 2), in some implementations. Additional details of embodiments of block 750, or for carrying out operations of block 750, are described in connection to FIG. 2, and in particular candidate topics identifier component 270.

At block 760, method 700 includes presenting a preset number of topics for each contact to the user to facilitate communication between the user and each contact regarding the preset number of topics. In this regard, one or more topics for a certain contact (or multiple contacts) can be presented to the user to facilitate communication with the certain contact or contacts regarding the one or more topics. For example, when a user navigates to a certain contact, a topic for the certain contact can be presented to the user via a GUI. In some embodiments, multiple topics are presented, and further the topics may be ordered such ranked according to frequency of the topics occurrence, as described herein. When the user communicates with the certain contact, such as by call, text, chat, message, email, or other communication, the user can address the topic or topics in the user's communication to the certain contact without having to manually determine the most relevant topics between the user and the certain contact. As another example, when a user has a meeting scheduled with a certain contact, one or more topics relevant to the certain contact can be presented to the user via a GUI. In some embodiments a plurality of topics are presented as a ranked or ordered list of topics. For example, as described herein, the topics may be ranked based on frequency of occurrence between the user and certain contact, based on recency, based on the number of different data sources in which the topics occur, a combination of these or another criterion. The user can address a topic during the meeting with the certain contact without having to manually identify the most relevant topics between the user and the certain contact. As still another example, when a user receives a communication from a certain contact, one or more topics for the certain contact can be presented to the user via a GUI. When the user responds to the communication with the certain contact, such as by call, text, chat, message, email, or the like, the user can address the topics, or a portion thereof, in the user's response to the certain contact without having to manually identify the topics between the user and the certain contact.

Some embodiments of block 760 comprise a preset number of topics for each contact is presented to the user from the ranked set of candidate topics. For example, a set of topic information items for each contact (or a portion thereof) may be assembled and formatted or prepared for presentation to the user via a GUI element, which may be modified to depict information regarding the topics for each contact. Some embodiments of block 760 comprise that a user or a third party can display topics between two or more other users. For example, a user can approve the display of topics between the user and contacts of the user in order to display the topics to a different user or a third party. For example, a user discusses a certain project frequently with other contacts and wishes to share the topic between the user and the other contacts with a third party or a different user. In this regard, the topic between the user and their contacts can be shared with the different user or third party. Some embodiments of block 760 comprise that the user can select a setting in a user interface whether to share topics between the user and the user's contacts with a different user or third party for privacy considerations.

Embodiments of block 760 may be carried out using presentation component 280 (FIG. 2), in some implementations. Additional details of embodiments of block 760, or for carrying out operations of block 760, are described in connection to FIG. 2, and in particular presentation component 280. Moreover, an example of topics identified for each contact of a user provided for presentation according to some embodiments of block 760 are illustratively depicted in FIG. 4 and described further in connection with the drawing.

Accordingly, we have described various aspects of technology directed to systems and methods for intelligently processing and presenting, on a computing device, group data that is contextualized for a user. It is understood that various features, sub-combinations, and modifications of the embodiments described herein are of utility and may be employed in other embodiments without reference to other features or sub-combinations. Moreover, the order and sequences of steps shown in the example methods 600 and 700 are not meant to limit the scope of the present disclosure in any way, and in fact, the steps may occur in a variety of different sequences within embodiments hereof. Such variations and combinations thereof are also contemplated to be within the scope of embodiments of this disclosure.

### Other Embodiments

In some embodiments, a computerized system to identify topics between a user and each contact of the user using a knowledge graph provided, such as the computerized system described in any of the embodiments above. The computerized system comprises at least one processor, and computer memory storing computer-readable instructions, that, when executed by the at least one processor, cause the at least one processor to perform operations. The operations comprise accessing a knowledge graph for a user. The knowledge graph comprises a plurality of nodes and a plurality of edges. The plurality of nodes corresponding to a plurality of contacts of the user, a plurality of data objects of the user, and a plurality of topics extracted from the plurality of data objects. The plurality of edges corresponding to interactions between each of the plurality of contacts and each of the plurality of data objects and relationships between each of the plurality of data objects and each of the plurality of topics. The operations may further comprise, accessing a subgraph of the knowledge graph, the subgraph of the knowledge graph comprising a set of nodes from the plurality of nodes and a set of edges from the plurality of edges corresponding to a particular contact. The operations may further comprise determining a set of candidate topics from the set of nodes based on corresponding interactions stored in the subgraph between the particular contact and corresponding data objects and corresponding relationships between the corresponding data objects and the set of candidate topics. The operations may further comprise ranking the set of candidate topics for the particular contact. The operations may further comprise generating a number of topics for the particular contact based on the ranking of the set of candidate topics. The operations may further comprise, responsive to at least one of navigating to the particular contact, a meeting with the particular contact and a communication with the particular contact, causing display of at least one topic from the number of topics associated with the particular contact. Advantageously, these and other embodiments, as described herein improve existing computing technologies by providing new or improved functionality in computing applications including automated computing technology for programmatically determining topics between a user and each contact of the user by utilizing a knowledge graph corresponding to the collaboration of the user and each of their contacts through various applications or platforms, as provided herein, can be beneficial for enabling improved computing applications and an improved user computing experience. For example, automated computing technology for programmatically identifying topics between a user and each contact of the user reduces the computing and networking resources utilized during communication between the user and a contact by facilitating suggestions of relevant topics so that the user is not required to manually identify, access, process, and review data between the contact and the user each time the user communicates with the contact. In this regard, the computing and network resources are conserved. Further, embodiments of this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Further still, embodiments described herein enable certain topic data for each contact of a user to be programmatically determined and presented without requiring computer tools and resources for a user to manually perform operations to produce this outcome. In this way, some embodiments, as described herein, reduce or eliminate a need for certain databases, data storage, and computer controls for enabling manually performed steps by an administrator, or the user themselves, to search, identify, assess, and configure (e.g., by hard-coding) specific, static data, thereby reducing the consumption of computing resources.

In any combination of the above embodiments of the system, the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node.

In any combination of the above embodiments of the system, determining the set of candidate topics further comprises: removing topics from the set of candidate topics corresponding to each of the plurality of data objects without activity within a threshold period of time; removing topics from the set of candidate topics below a threshold quality value; removing topics from the set of candidate topics from a single source of in the plurality of data objects; and merging similar topics of the set of candidate topics.

In any combination of the above embodiments of the system, merging similar topics of the set of candidate topics further comprises: merging triples of similar topics of the set of candidate topics when a Jaccard distance between any pair of topics in the triples of similar topics is below a certain threshold; removing topics of the set of candidate topics contained within other topics of the set of candidate topics; and clustering topics in the set of candidate topics by their Levenshtein distance.

In any combination of the above embodiments of the system, determining the set of candidate topics further comprises: ranking each topic from the set of nodes using a PageRank algorithm based on keywords corresponding to each topic in the plurality of data objects; and determining each candidate topic of the set of candidate topics based on each topic from the set of nodes above a threshold ranking in the PageRank algorithm.

In any combination of the above embodiments of the system, determining the set of candidate topics further comprises: removing each candidate topic from the set of candidate topics inferred for above a threshold percentage of a set of the plurality of contacts.

In any combination of the above embodiments of the system, ranking the set of candidate topics for the particular contact further comprises: ranking each candidate topic in the set of candidate topics using term frequency-inverse document frequency.

In any combination of the above embodiments of the system, causing presentation of the first topic, from the number of topics associated with the particular contact, further comprises: displaying the first topic via a graphical user interface of an address book application, the first topic displayed in association with an indication of the particular contact; displaying the first topic via graphical user interface of a meeting application, the first topic displayed in association with the indication of the particular contact; or displaying the first topic via a graphical user interface of a communication application, the first topic displayed in proximity to the communication with the particular contact.

In some embodiments, a computer-implemented method is provided. The method comprises accessing a knowledge graph for a user. The knowledge graph comprising a plurality of nodes and a plurality of edges. The plurality of nodes corresponding to a plurality of contacts of the user and a plurality of data objects of the user. The plurality of edges corresponding to interactions between each of the plurality of contacts and each of the plurality of data objects. The method further comprises determining a set of contacts from the plurality of contacts of the knowledge graph for the user. The method further comprises determining a plurality of topics from the plurality of data objects of the knowledge graph for the user. The method further comprises, for a contact of the set of contacts, determining at least one candidate topic from the plurality of topics based on corresponding interactions stored in the knowledge graph between the contact and corresponding data objects of the plurality of data objects. The method further comprises, responsive to at least one of navigating to the contact, a meeting with the contact and a communication with the contact, causing display of the contact with the at least one candidate topic corresponding to the contact. Advantageously, these and other embodiments, as described herein improve existing computing technologies by providing new or improved functionality in computing applications including automated computing technology for programmatically determining topics between a user and each contact of the user by utilizing a knowledge graph corresponding to the collaboration of the user and each of their contacts through various applications or platforms, as provided herein, can be beneficial for enabling improved computing applications and an improved user computing experience. For example, automated computing technology for programmatically identifying topics between a user and each contact of the user reduces the computing and networking resources utilized during communication between the user and a contact by facilitating suggestions of relevant topics so that the user is not required to manually identify, access, process, and review data between the contact and the user each time the user communicates with the contact. In this regard, the computing and network resources are conserved. Further, embodiments of this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Further still, embodiments described herein enable certain topic data for each contact of a user to be programmatically determined and presented without requiring computer tools and resources for a user to manually perform operations to produce this outcome. In this way, some embodiments, as described herein, reduce or eliminate a need for certain databases, data storage, and computer controls for enabling manually performed steps by an administrator, or the user themselves, to search, identify, assess, and configure (e.g., by hard-coding) specific, static data, thereby reducing the consumption of computing resources.

In any combination of the above embodiments of the method, the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node.

In any combination of the above embodiments of the method, the plurality of topics are stored as nodes in the knowledge graph and relationships between each of the plurality of topics and the plurality of data objects are stored as edges in the knowledge graph.

In any combination of the above embodiments of the method, determining the set of contacts from the plurality of contacts further comprises: removing duplicate contacts in the plurality of contacts; removing non-human contacts in the plurality of contacts; ranking each contact in the plurality of contacts based on importance correlated to how connected each contact is with the user in the knowledge graph; and determining each contact in the set of contacts above a threshold ranking.

In any combination of the above embodiments of the method, determining the plurality of topics from the plurality of data objects further comprises: determining, using a language model, a plurality of keywords in the plurality of data objects; and determining the plurality of topics from the plurality of keywords.

In any combination of the above embodiments of the method, determining the plurality of topics further comprises: removing topics from the plurality of topics from each data object in the plurality of data objects without activity within a threshold period of time; removing topics from the plurality of topics below a threshold quality value; removing topics from the plurality of topics from a single source of in the plurality of data objects; and merging similar topics of the plurality of topics.

In any combination of the above embodiments of the method, merging similar topics of the plurality of topics further comprises: merging triples of similar topics of the plurality of topics when a Jaccard distance between any pair of topics in the triples of similar topics is below a certain threshold; removing topics of the plurality topics contained within other topics of the plurality of topics; and clustering topics in the plurality of topics by their Levenshtein distance.

In any combination of the above embodiments of the method, determining at least one candidate topic from the plurality of topics further comprises: determining a set of candidate topics from the plurality of topics; ranking each candidate topic in the set of candidate topics using a PageRank algorithm based on keywords corresponding to each candidate topic in the plurality of interactions with the set of contacts stored in the knowledge graph; and determining the at least one candidate topic of the set of candidate topics above a threshold ranking.

In any combination of the above embodiments of the method, determining the set of candidate topics from the plurality of topics further comprises: removing candidate topics from the set of candidate topics inferred for above a threshold percentage of the set of contacts; merging triples of similar candidate topics of the set of candidate topics when a Jaccard distance between any pair of candidate topics in the triples of similar candidate topics is below a certain threshold; removing candidate topics of the set of candidate topics contained within other candidate topics of the set of candidate topics; and clustering candidate topics in the set of candidate topics by their Levenshtein distance.

In any combination of the above embodiments of the method, determining the at least one candidate topic of the set of candidate topics above a threshold ranking further comprises: ranking each candidate topic using term frequency-inverse document frequency; and determining the at least one candidate topic above a threshold ranking.

In some embodiments, one or more computer storage media having computer-executable instructions embodied thereon that, when executed by a computing system having at least one processor and at least one memory, cause the at least one processor to perform operations. The operations comprise accessing a knowledge graph for a user. The knowledge graph comprising a plurality of nodes and a plurality of edges. The plurality of nodes corresponding to a plurality of contacts of the user, a plurality of data objects of the user, and a plurality of topics extracted from the plurality of data objects. The plurality of edges corresponding to interactions between each of the plurality of contacts and each of the plurality of data objects and relationships between each of the plurality of data objects and each of the plurality of topics. The operations may further comprise determining a set of contacts from the plurality of contacts of the knowledge graph for the user. The operations may further comprise, for each contact of the set of contacts, accessing a subgraph of the knowledge graph, the subgraph of the knowledge graph comprising a set of nodes from the plurality of nodes and a set of edges from the plurality of edges corresponding to each contact. The operations may further comprise, for each contact of the set of contacts, determining a set of candidate topics from the set of nodes based on corresponding interactions stored in the subgraph between each contact and corresponding data objects and corresponding relationships between the corresponding data objects and the set of candidate topics. The operations may further comprise, for each contact of the set of contacts, ranking the set of candidate topics for each contact. The operations may further comprise, for each contact of the set of contacts, generating a number of topics for each contact based on the ranking of the set of candidate topics. The operations may further comprise, responsive to at least one of navigating to a particular contact of the set of contacts, a meeting with the particular contact of the set of contacts and a communication with the particular contact of the set of contacts, causing display of at least one topic from the number of topics generated for the particular contact. Advantageously, these and other embodiments, as described herein improve existing computing technologies by providing new or improved functionality in computing applications including automated computing technology for programmatically determining topics between a user and each contact of the user by utilizing a knowledge graph corresponding to the collaboration of the user and each of their contacts through various applications or platforms, as provided herein, can be beneficial for enabling improved computing applications and an improved user computing experience. For example, automated computing technology for programmatically identifying topics between a user and each contact of the user reduces the computing and networking resources utilized during communication between the user and a contact by facilitating suggestions of relevant topics so that the user is not required to manually identify, access, process, and review data between the contact and the user each time the user communicates with the contact. In this regard, the computing and network resources are conserved. Further, embodiments of this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Further still, embodiments described herein enable certain topic data for each contact of a user to be programmatically determined and presented without requiring computer tools and resources for a user to manually perform operations to produce this outcome. In this way, some embodiments, as described herein, reduce or eliminate a need for certain databases, data storage, and computer controls for enabling manually performed steps by an administrator, or the user themselves, to search, identify, assess, and configure (e.g., by hard-coding) specific, static data, thereby reducing the consumption of computing resources.

In any combination of the above embodiments, the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node.

In any combination of the above embodiments, determining the set of candidate topics further comprises: removing topics from the set of candidate topics corresponding to each of the plurality of data objects without activity within a threshold period of time; removing topics from the set of candidate topics below a threshold quality value; removing topics from the set of candidate topics from a single source of in the plurality of data objects; and merging similar topics of the set of candidate topics.

### Example Computing Environments

Having described various implementations, several example computing environments suitable for implementing embodiments of the disclosure are now described, including an example computing device and an example distributed computing environment in FIGS. 8 and 9, respectively. With reference to FIG. 8, an exemplary computing device is provided and referred to generally as computing device 800. The computing device 800 is but one example of a suitable computing environment and is not intended to suggest any limitation as to the scope of use or functionality of embodiments of the disclosure. Neither should the computing device 800 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating to, for example, logic, control, and memory operations. Low level software written in machine code can provide more complex functionality to higher levels of software. Accordingly, in some embodiments, computer-executable instructions may include any software, including low level software written in machine code, higher level software such as application software, and any combination thereof. In this regard, the system components can manage resources and provide services for system functionality. Any other variations and combinations thereof are contemplated with the embodiments of the present disclosure.

With reference to FIG. 8, computing device 800 includes a bus 810 that directly or indirectly couples the following devices: memory 812, one or more processors 814, one or more presentation components 816, one or more input/output (I/O) ports 818, one or more I/O components 820, and an illustrative power supply 822. Bus 810 represents what may be one or more buses (such as an address bus, data bus, or combination thereof). Although the various blocks of FIG. 8 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more embodiments of the present disclosure. Distinction is not made between such categories as “workstation,” “server,” “laptop,” or “handheld device,” as all are contemplated within the scope of FIG. 8 and with reference to “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include, for example, solid-state memory, hard drives, and optical-disc drives. Computing device 800 includes one or more processors 814 that read data from various entities such as memory 812 or I/O components 820. Presentation component(s) 816 presents data indications to a user or other device. Exemplary presentation components include a display device, speaker, printing component, vibrating component, and the like.

The I/O ports 818 allow computing device 800 to be logically coupled to other devices, including I/O components 820, some of which may be built in. Illustrative components include a microphone, joystick, game pad, satellite dish, scanner, printer, or a wireless device. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

Some embodiments of computing device 800 may include one or more radio(s) 824 (or similar wireless communication components). The radio transmits and receives radio or wireless communications. The computing device 800 may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (for example, a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Referring now to FIG. 9, an example distributed computing environment 900 is illustratively provided, in which implementations of the present disclosure may be employed. In particular, FIG. 9 shows a high level architecture of an example cloud computing platform 910 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 900 that includes cloud computing platform 910, rack 920, and node 930 (e.g., computing devices, processing units, or blades) in rack 920. The technical solution environment can be implemented with cloud computing platform 910, which runs cloud services across different data centers and geographic regions. Cloud computing platform 910 can implement fabric controller 940 component for provisioning and managing resource allocation, deployment, upgrade, and management of cloud services. Typically, cloud computing platform 910 acts to store data or run service applications in a distributed manner. Cloud computing infrastructure 910 in a data center can be configured to host and support operation of endpoints of a particular service application. Cloud computing infrastructure 910 may be a public cloud, a private cloud, or a dedicated cloud.

Node 930 can be provisioned with host 950 (e.g., operating system or runtime environment) running a defined software stack on node 930. Node 930 can also be configured to perform specialized functionality (e.g., compute nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multi-tenant infrastructure or tenancy. The terms “service application,” “application,” or “service” are used interchangeably with regards to FIG. 9, and broadly refer to any software, or portions of software, that run on top of, or access storage and computing device locations within, a datacenter.

When more than one separate service application is being supported by nodes 930, nodes 930 may be partitioned into virtual machines (e.g., virtual machine 952 and virtual machine 954). Physical machines can also concurrently run separate service applications. The virtual machines or physical machines can be configured as individualized computing environments that are supported by resources 960 (e.g., hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In particular, the servers may perform data operations independently but exposed as a single device, referred to as a cluster. Each server in the cluster can be implemented as a node.

Client device 980 may be linked to a service application in cloud computing platform 910. Client device 980 may be any type of computing device, such as user device 102n described with reference to FIG. 1, and the client device 980 can be configured to issue commands to cloud computing platform 910. In embodiments, client device 980 may communicate with service applications through a virtual Internet Protocol (IP) and load balancer or other means that direct communication requests to designated endpoints in cloud computing platform 910. The components of cloud computing platform 910 may communicate with each other over a network (not shown), which may include, without limitation, one or more local area networks (LANs) and/or wide area networks (WANs).

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a computing device or a distributed computing environment; however the computing device and distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computerized system for facilitating computer-resource efficient communication between users, comprising:
at least one processor; and
computer memory storing computer-useable instructions that, when executed by the at least one processor, cause the at least one processor to perform operations comprising:
accessing a knowledge graph for a user, the knowledge graph comprising a plurality of nodes and a plurality of edges, each node corresponding to a contact of the user, a data object associated with the user, or a topic determined from the data object, each edge connecting two nodes and corresponding to an interaction between the contact and the data object or corresponding to a relationship between the data object and the topic;
accessing a subgraph of the knowledge graph, the subgraph of the knowledge graph including a set of nodes comprising at least two nodes from the plurality of nodes and a set of edges comprising at least one edge from the plurality of edges corresponding to a particular contact;
determining, from the set of nodes, a set of candidate topics including at least one candidate topic, the set of candidate topics determined based on a corresponding interaction stored in the subgraph and represented as a first edge between the particular contact and a corresponding data object and a corresponding relationship, represented as a second edge, between the corresponding data object and a corresponding particular candidate topic;
ranking the set of candidate topics for the particular contact;
generating a number of topics associated with the particular contact based on the ranking of the set of candidate topics; and
responsive to at least one of navigating to the particular contact, a meeting with the particular contact and a communication with the particular contact, causing presentation of a first topic from the number of topics associated with the particular contact.

2. The computerized system of claim 1, wherein the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node.

3. The computerized system of claim 1, wherein determining the set of candidate topics further comprises:
removing topics from the set of candidate topics corresponding to each of the plurality of data objects without having an activity associated therewith within a threshold period of time;
removing topics from the set of candidate topics below a threshold quality value;
removing topics from the set of candidate topics from a single source of in the plurality of data objects; and
merging similar topics of the set of candidate topics.

4. The computerized system of claim 3, wherein merging similar topics of the set of candidate topics further comprises:
merging triples of similar topics of the set of candidate topics when a Jaccard distance between any pair of topics in the triples of similar topics is below a certain threshold;
removing topics of the set of candidate topics contained within other topics of the set of candidate topics; and
clustering topics in the set of candidate topics by their Levenshtein distance.

5. The computerized system of claim 1, wherein determining the set of candidate topics further comprises:
ranking each topic from the set of nodes using a PageRank algorithm based on keywords corresponding to each topic in the plurality of data objects; and
determining each candidate topic of the set of candidate topics based on each topic from the set of nodes above a threshold ranking in the PageRank algorithm.

6. The computerized system of claim 1, wherein determining the set of candidate topics further comprises:
determining, based on the subgraph, that a first candidate topic of the set of candidate topics is associated with a plurality of contacts that exceeds a threshold percentage; and
removing the first candidate topic from the set of candidate topics; and
wherein ranking the set of candidate topics for the particular contact further comprises ranking each candidate topic in the set of candidate topics using term frequency-inverse document frequency.

7. The computerized system of claim 1, wherein causing presentation of the first topic, from the number of topics associated with the particular contact, further comprises:
displaying the first topic via a graphical user interface of an address book application, the first topic displayed in association with an indication of the particular contact;
displaying the first topic via graphical user interface of a meeting application, the first topic displayed in association with the indication of the particular contact; or
displaying the first topic via a graphical user interface of a communication application, the first topic displayed in proximity to the communication with the particular contact.

8. A computer-implemented method for preserving computing and network resources for communications between users, comprising:
accessing a knowledge graph for a user, the knowledge graph comprising a plurality of nodes and a plurality of edges, the plurality of nodes corresponding to a plurality of contacts of the user and a plurality of data objects of the user, the plurality of edges corresponding to interactions between each of the plurality of contacts and each of the plurality of data objects;
determining a set of contacts from the plurality of contacts of the knowledge graph for the user;
determining a plurality of topics from the plurality of data objects of the knowledge graph for the user;
for a contact of the set of contacts, determining at least one candidate topic from the plurality of topics based on corresponding interactions stored in the knowledge graph between the contact and corresponding data objects of the plurality of data objects; and
responsive to at least one of navigating to the contact, a meeting with the contact and a communication with the contact, causing display of the contact with the at least one candidate topic corresponding to the contact.

9. The computer-implemented method of claim 8, wherein the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node.

10. The computer-implemented method of claim 8, wherein the plurality of topics are stored as nodes in the knowledge graph and relationships between each of the plurality of topics and the plurality of data objects are stored as edges in the knowledge graph.

11. The computer-implemented method of claim 8, wherein determining the set of contacts from the plurality of contacts further comprises:
removing duplicate contacts in the plurality of contacts;
removing non-human contacts in the plurality of contacts;
ranking each contact in the plurality of contacts based on importance correlated to how connected each contact is with the user in the knowledge graph; and
determining each contact in the set of contacts above a threshold ranking.

12. The computer-implemented method of claim 8, wherein determining the plurality of topics from the plurality of data objects further comprises:
determining, using a language model, a plurality of keywords in the plurality of data objects; and
determining the plurality of topics from the plurality of keywords.

13. The computer-implemented method of claim 8, wherein determining the plurality of topics further comprises:
removing topics from the plurality of topics from each data object in the plurality of data objects without activity within a threshold period of time;
removing topics from the plurality of topics below a threshold quality value;
removing topics from the plurality of topics from a single source of in the plurality of data objects; and
merging similar topics of the plurality of topics.

14. The computer-implemented method of claim 13, wherein merging similar topics of the plurality of topics further comprises:
merging triples of similar topics of the plurality of topics when a Jaccard distance between any pair of topics in the triples of similar topics is below a certain threshold;
removing topics of the plurality topics contained within other topics of the plurality of topics; and
clustering topics in the plurality of topics by their Levenshtein distance.

15. The computer-implemented method of claim 8, wherein determining at least one candidate topic from the plurality of topics further comprises:
determining a set of candidate topics from the plurality of topics;
ranking each candidate topic in the set of candidate topics using a PageRank algorithm based on keywords corresponding to each candidate topic in the plurality of interactions with the set of contacts stored in the knowledge graph; and
determining the at least one candidate topic of the set of candidate topics above a threshold ranking.

16. The computer-implemented method of claim 15, wherein determining the set of candidate topics from the plurality of topics further comprises:
removing candidate topics from the set of candidate topics inferred for above a threshold percentage of the set of contacts;
merging triples of similar candidate topics of the set of candidate topics when a Jaccard distance between any pair of candidate topics in the triples of similar candidate topics is below a certain threshold;
removing candidate topics of the set of candidate topics contained within other candidate topics of the set of candidate topics; and
clustering candidate topics in the set of candidate topics by their Levenshtein distance.

17. The computer-implemented method of claim 15, wherein determining the at least one candidate topic of the set of candidate topics above a threshold ranking further comprises:
ranking each candidate topic using term frequency-inverse document frequency; and
determining the at least one candidate topic above a threshold ranking.

18. One or more computer storage media having computer-executable instructions embodied thereon that, when executed by a computing system having at least one processor and at least one memory, cause the at least one processor to perform operations comprising:
accessing a knowledge graph for a user, the knowledge graph comprising a plurality of nodes and a plurality of edges, the plurality of nodes corresponding to a plurality of contacts of the user, a plurality of data objects of the user, and a plurality of topics extracted from the plurality of data objects, the plurality of edges corresponding to interactions between each of the plurality of contacts and each of the plurality of data objects and relationships between each of the plurality of data objects and each of the plurality of topics;
determining a set of contacts from the plurality of contacts of the knowledge graph for the user;
for each contact of the set of contacts:
accessing a subgraph of the knowledge graph, the subgraph of the knowledge graph comprising a set of nodes from the plurality of nodes and a set of edges from the plurality of edges corresponding to each contact;
determining a set of candidate topics from the set of nodes based on corresponding interactions stored in the subgraph between each contact and corresponding data objects and corresponding relationships between the corresponding data objects and the set of candidate topics;
ranking the set of candidate topics for each contact; and
generating a number of topics for each contact based on the ranking of the set of candidate topics; and
responsive to at least one of navigating to a particular contact of the set of contacts, a meeting with the particular contact of the set of contacts and a communication with the particular contact of the set of contacts, causing display of a first topic, from the number of topics, generated for the particular contact.

19. The one or more computer storage media of claim 18:
wherein the knowledge graph further comprises edge weights corresponding to a strength of each interaction and relationship, each of the nodes ranked by importance, and each feature stored with respect to each node corresponding to each of the plurality of data objects, each feature indicating an action of the user with respect to the node; and wherein determining the set of candidate topics further comprises:
removing topics from the set of candidate topics corresponding to each of the plurality of data objects without activity within a threshold period of time;
removing topics from the set of candidate topics below a threshold quality value;
removing topics from the set of candidate topics from a single source of in the plurality of data objects; and
merging similar topics of the set of candidate topics.

20. The one or more computer storage media of claim 18, wherein causing display of the first topic, from the number of topics associated with the particular contact, further comprises:
displaying the first topic via a graphical user interface of an address book application, the first topic displayed in association with an indication of the particular contact;
displaying the first topic via graphical user interface of a meeting application, the first topic displayed in association with the indication of the particular contact; or
displaying the first topic via a graphical user interface of a communication application, the first topic displayed in proximity to the communication with the particular contact.
